(19) United States
(12) Patent Application Publication
(10) Pub. No.: US 2026/0238833 A1
(43) Pub. Date: Aug. 13, 2026

(54) Reordering Decoder-side Intra Mode Derivation Merge Mode Candidates

(71) Applicant: Ofinno, LLC, Reston, VA (US)

(72) Inventors: Médéric Blestel, Bruz (FR); Pierre Jean Andrivon, Liffre (FR)

(73) Assignee: Ofinno, LLC, Reston, VA (US)

(21) Appl. No.: 19/638,617

(22) Filed: Apr. 3, 2026

Related U.S. Application Data
(63) Continuation of application No. PCT/US2024/049876, filed on Oct. 4, 2024.
(60) Provisional application No. 63/543,217, filed on Oct. 9, 2023.

(51) Int. Cl. H04N 19/88; H04N 19/105; H04N 19/176

(52) U.S. Cl. CPC H04N 19/88; H04N 19/105; H04N 19/176

(57) ABSTRACT

A video coder (encoder or decoder) reorders a list of merge candidates. The list of merge candidates comprises a merge candidate comprising decoder-side intra mode derivation (DIMD) information or template-based intra mode derivation (TIMD) information associated with a spatially neighboring block of a current block in a current frame. The video coder determines an indicator of the merge candidate in the list of merge candidates and codes the current block based on the DIMD information of the merge candidate in the list of merge candidates according to the indicator.

### CROSS-REFERENCE TO RELATED APPLICATIONS

This application is a continuation of International Application No. PCT/US2024/049876, filed Oct. 4, 2024, which claims the benefit of U.S. Provisional Application No. 63/543,217, filed Oct. 9, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17 illustrates an example of intra template matching search areas in accordance with some embodiments of the present disclosure.

FIG. 18 illustrates an example of decoder-side intra mode derivation (DIMD) template zone for computing a histogram of gradients (HoG) in accordance with some embodiments of the present disclosure.

FIGS. 19A and 19B illustrate a flowchart of an example process for DIMD predictor derivation in accordance with some embodiments of the present disclosure.

FIG. 20 illustrates an example prediction fusion by weighted averaging of two HoG modes and planar mode in accordance with some embodiments of the present disclosure.

FIG. 21 illustrates an example of aspects associated with template-based intra mode derivation (TIMD) in accordance with some embodiments of the present disclosure.

FIG. 22 illustrates a flowchart of an example process for TIMD predictor generation in accordance with some embodiments of the present disclosure.

FIG. 23 illustrates a flowchart of an example process for DIMD merge mode in accordance with some embodiments of the present disclosure.

FIG. 24 illustrates example spatial adjacent neighboring blocks considered in the derivation of the list of DIMD merge candidates in accordance with some embodiments of the present disclosure.

FIG. 25 illustrates example spatial non-adjacent neighboring blocks used to derive DIMD merge candidates in accordance with some embodiments of the present disclosure.

FIG. 26 illustrates a flowchart of an example process for adding DIMD information from spatial neighboring blocks to the history-based DIMD table in accordance with some embodiments of the present disclosure.

FIG. 27 illustrates a flowchart of an example process for deriving an index into the list of DIMD merge candidates in accordance with some embodiments of the present disclosure.

FIG. 28 illustrates a flowchart of a process for generating the list of DIMD merge candidate without duplicate DIMD information and enforcing predetermined thresholds for a maximum list size and maximal number of candidates from respective families of candidates, in accordance with some embodiments of the present disclosure.

FIG. 29 illustrates a flowchart of an example process to generate a reordered list of DIMD merge candidates in accordance with some embodiments of the present disclosure.

FIG. 30 illustrates an example of a template that can be used in template-based reordering of the list of DIMD merge candidates in accordance with some embodiments of the present disclosure.

FIG. 31 illustrates a flowchart of an example process for vertical location dependency-based reordering of the list of DIMD merge candidates in accordance with some embodiments of the present disclosure.

FIG. 32 illustrates a flowchart of an example process for generating the list of DIMD merge candidates with template-based reordering of a part of the list in accordance with some embodiment of the present disclosure.

FIG. 33 illustrates a flowchart of an example process for generating the list of DIMD merge candidates with the addition of DIMD merge candidate derived from a template-based intra mode derivation (TIMD) according to some embodiments of the present disclosure.

FIG. 34 illustrates a flowchart of a method for DIMD merge mode encoding in accordance with some embodiments of the present disclosure. The method includes generating the list of DIMD merge candidates and reordering the list before the intra mode is determined.

FIG. 35 illustrates a flowchart of another method for DIMD merge mode decoding in accordance with some embodiments of the present disclosure. The method includes generating the list of DIMD merge candidates and reordering the list before the intra mode is determined in accordance with an indicator obtained from the bitstream.

FIG. 36 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications. Video encoding may be used to compress the size of a video sequence to provide for more efficient storage and/or transmission. Video decoding may be used to decompress a compressed video sequence for display and/or other forms of consumption.

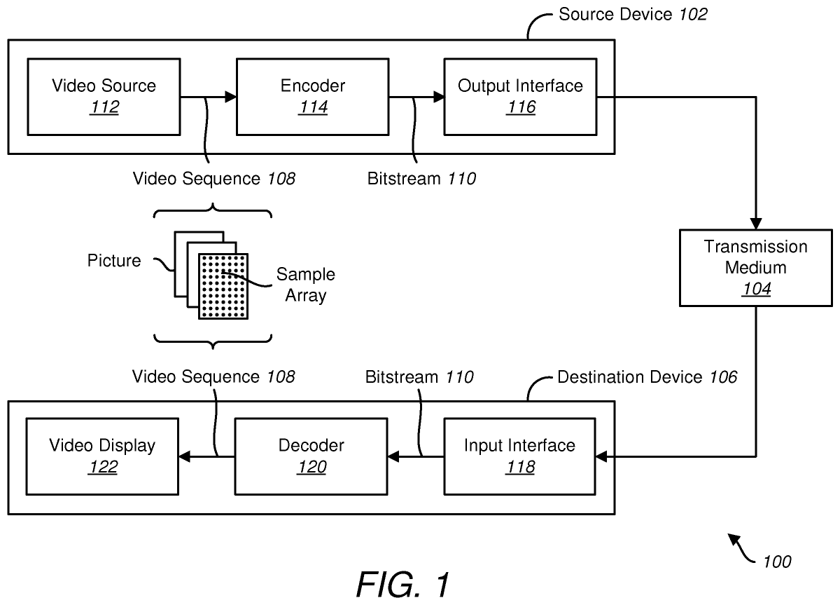

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, liquid crystal display (LCD), a plasma display, light emitting diode (LED) display, or any other display device suitable for displaying video sequence 108.

It should be noted that video encoding/decoding system 100 is presented by way of example and not limitation. In the example of FIG. 1, video encoding/decoding system 100 may have other components and/or arrangements. For example, video source 112 may be external to source device 102. Similarly, video display 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bitstream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC), ITU-T H.265 and MPEG-H Part 2 (also known as High Efficiency Video Coding (HEVC), ITU-T H.265 and MPEG-I Part 3 (also known as Versatile Video Coding (VVC)), the WebM VP8 and VP9 codecs, and AOMedia Video 1 (AV1).

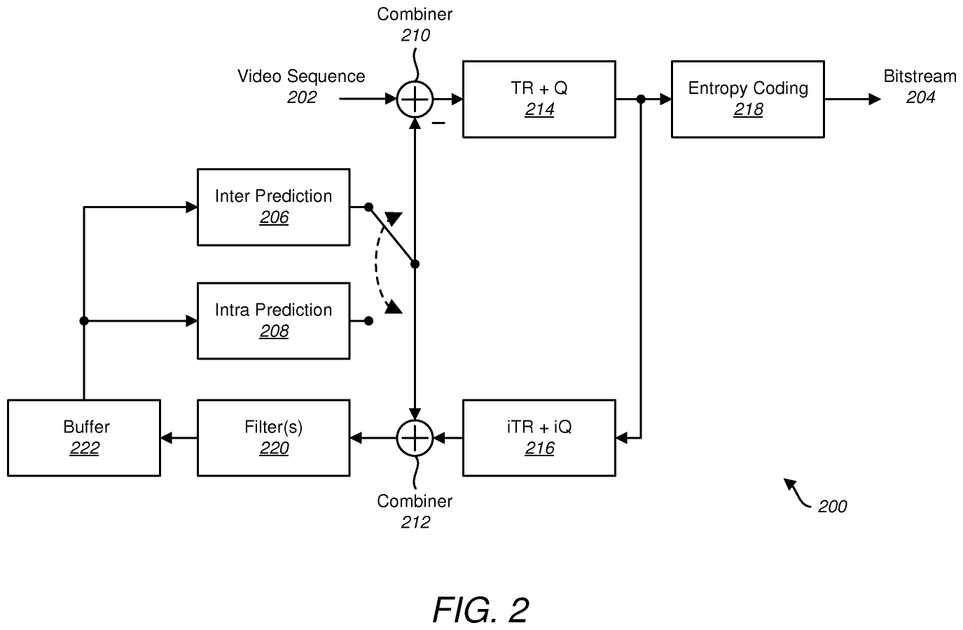

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, The encoder control unit may control the one or more units of encoder 200 such that bitstream 204 is generated in conformance with one or more of ITU-T H.263, AVC, HEVC, VVC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. For example, entropy coding unit 218 may apply context adaptive variable length coding (CAVLC), context adaptive binary arithmetic coding (CABAC), and syntax-based context-based binary arithmetic coding (SBAC) to compress the prediction type used to encode a block (intra or inter prediction), prediction information of the block (intra prediction mode if intra predicted, motion vector, etc.), and transform and quantization parameters. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filters(s) 220.

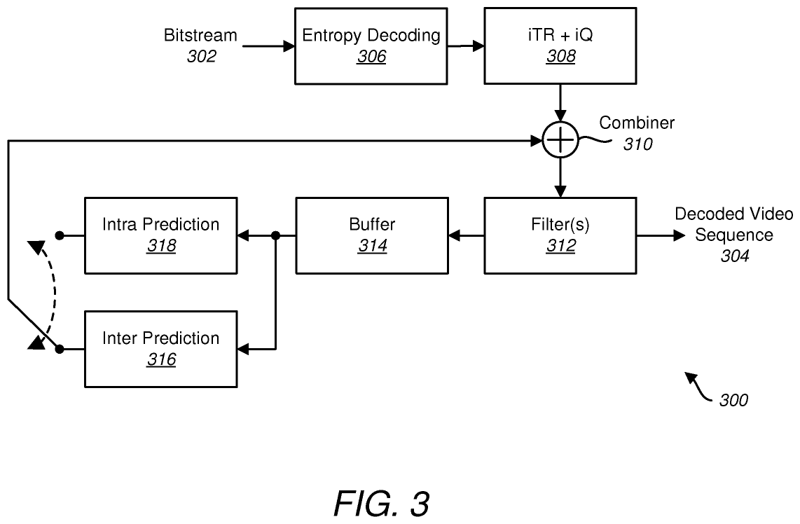

FIG. 3 illustrates an exemplary decoder 300 in which embodiments of the present disclosure may be implemented. Decoder 300 decodes a bitstream 302 into a decoded video sequence 304 for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, The decoder control unit may control the one or more units of decoder 300 such that bitstream 302 is decoded in conformance with one or more of ITU-T H.263, AVC, HEVC, VVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filters(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2n×2n samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode may be applied. For transformations, a CB may be partitioned into one or more transform blocks (TBs). A TB may be a rectangular block of samples that may determine an applied transform size.

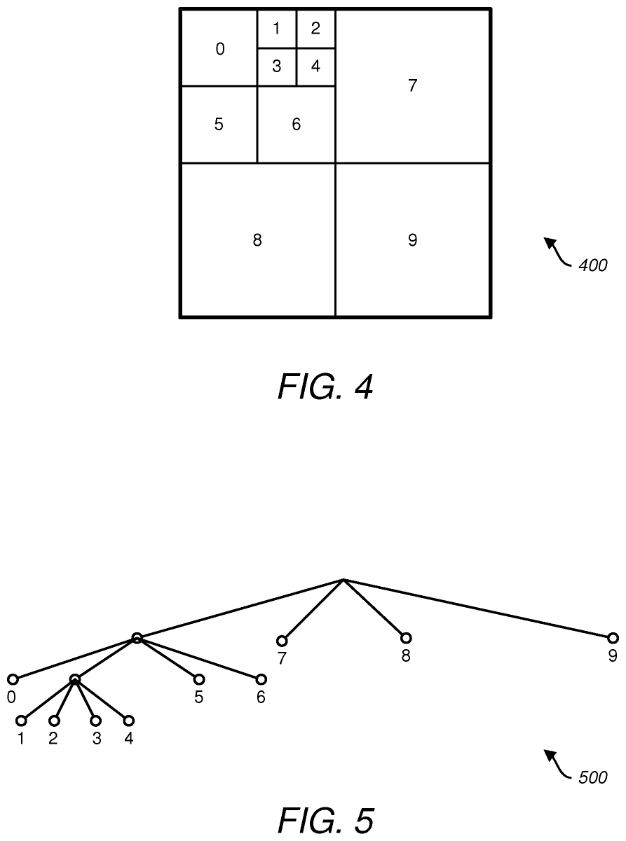

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

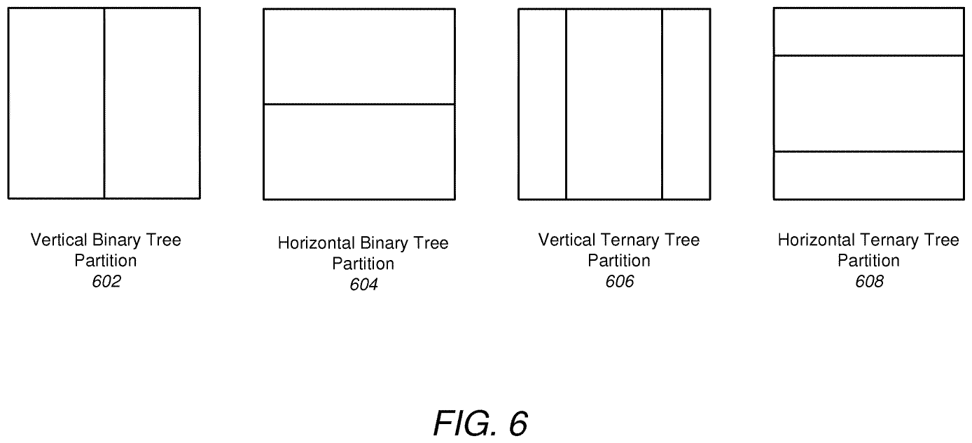

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

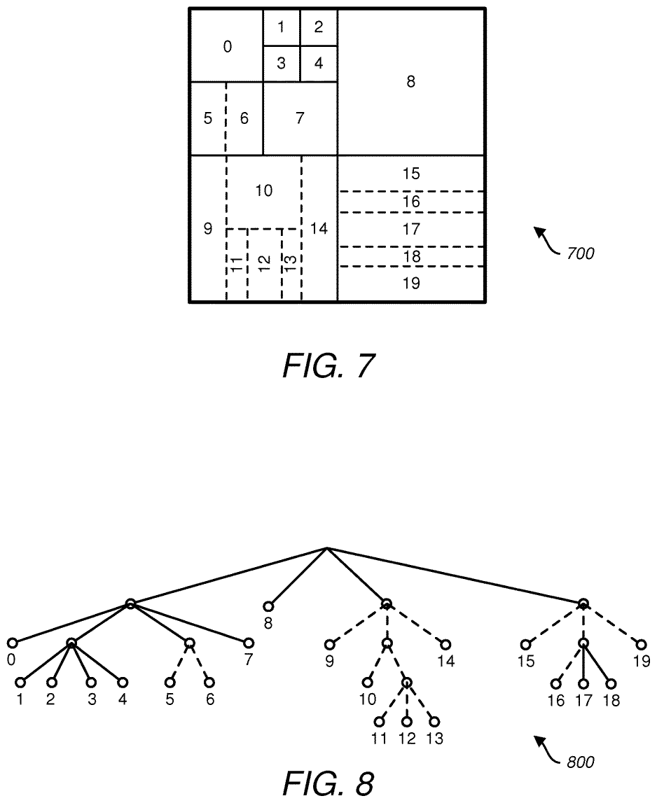

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and VVC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and VVC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

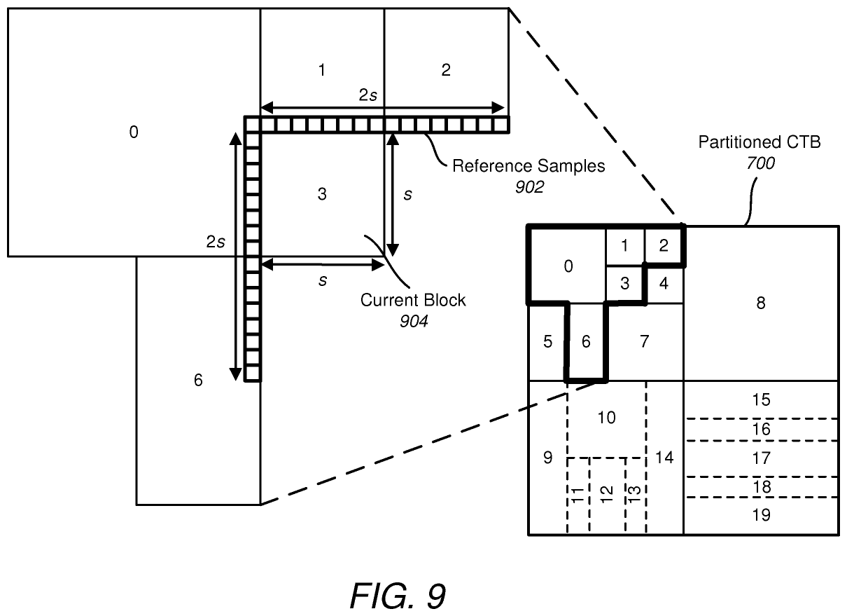

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in VVC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

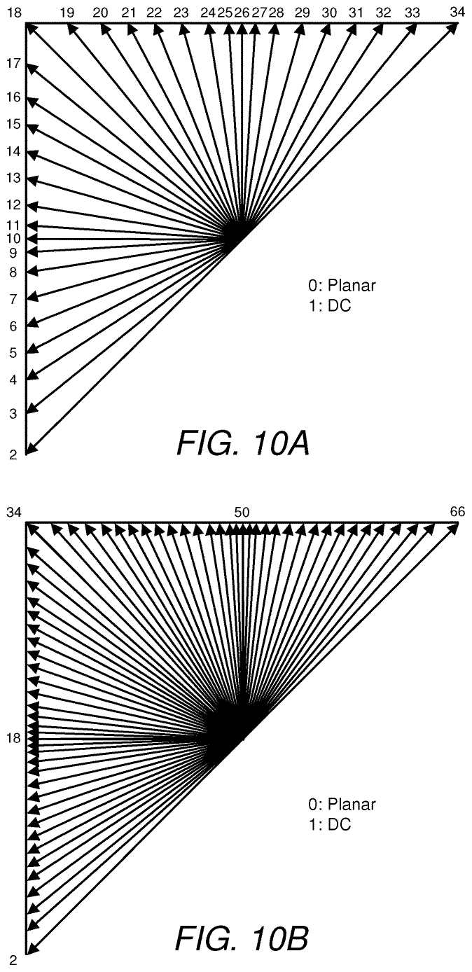

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Because blocks in VVC may be non-square, some of the intra prediction modes illustrated in FIG. 10B may be adaptively replaced by wide-angle directions.

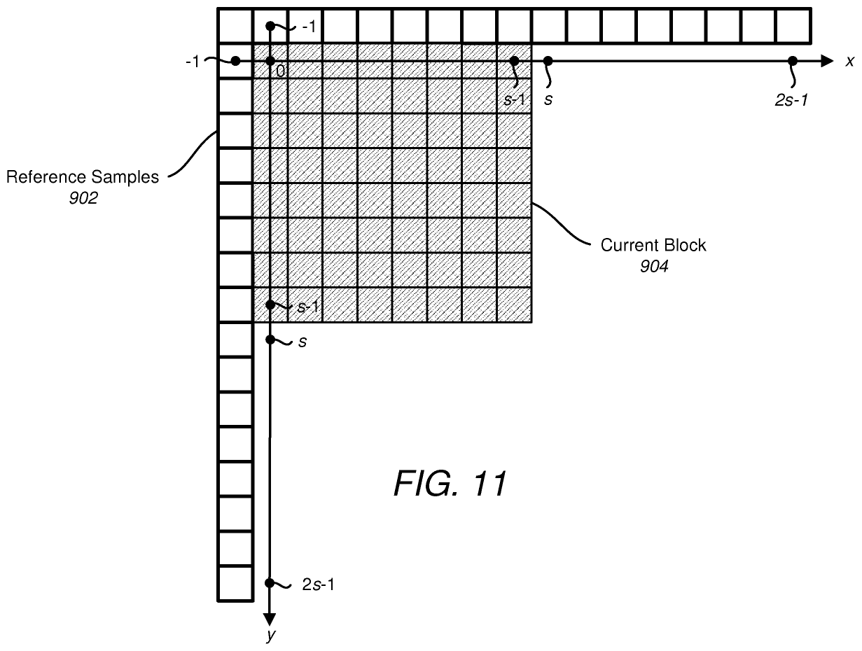

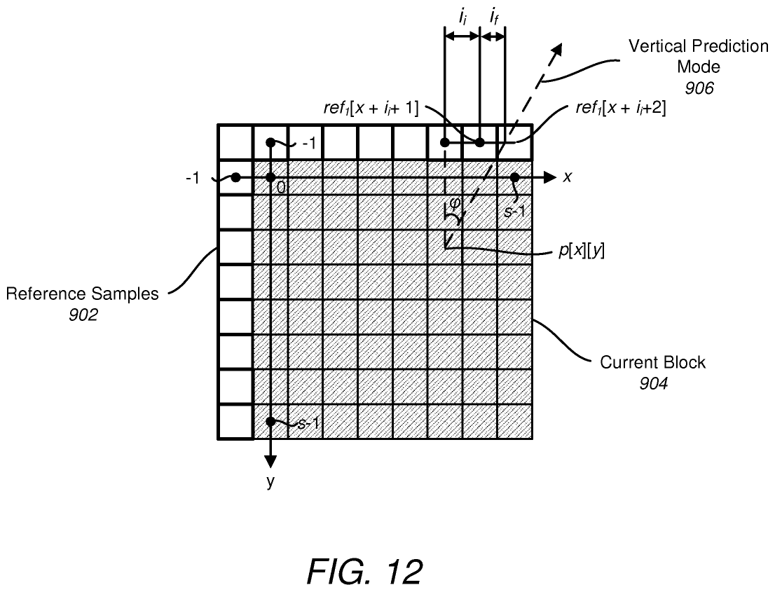

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x][y]. In order to simplify the prediction process, reference samples 902 may be placed in two, one-dimensional arrays. Reference samples 902 above current block 904 may be placed in the one-dimensional array ref₁[x]:

$${ref}_{1} [ x ] = p [ - 1 + x ] [ - 1 ] , ( x \geq 0 ) \qquad ( 1 )$$

Reference samples 902 to the left of current block 904 may be placed in the one-dimensional array ref₂[x]:

$${ref}_{2} [ y ] = p [ - 1 ] [ - 1 + y ] , ( y \geq 0 ) \qquad ( 2 )$$

For planar mode, a sample at location [x][y] in current block 904 may be predicted by calculating the mean of two interpolated values. The first of the two interpolated values may be based on a horizontal linear interpolation at location [x][y] in current block 904. The second of the two interpolated values may be based on a vertical linear interpolation at location [x][y] in current block 904. The predicted sample p[x][y] in current block 904 may be calculated as

$$p [ x ] [ y ] = \frac{1}{2 \cdot s} ( h [ x ] [ y ] + v [ x ] [ y ] + s ) where \qquad ( 3 )$$

$$h [ x ] ⌈ y ] = ( s - x - 1 ) \cdot {ref}_{2} [ y ] + ( x + 1 ) \cdot {ref}_{1} [ s ] \qquad ( 4 )$$

may be the horizonal linear interpolation at location [x][y] in current block 904 and

$$v [ x ] ⌈ y ] = ( s - y - 1 ) \cdot {ref}_{1} [ x ] + ( y + 1 ) \cdot {ref}_{2} [ s ] \qquad ( 5 )$$

may be the vertical linear interpolation at location [x][y] in current block 904.

For DC mode, a sample at location [x][y] in current block 904 may be predicted by the mean of the reference samples 902. The predicted value sample p[x][y] in current block 904 may be calculated as

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) \qquad ( 6 )$$

For angular modes, a sample at location [x][y] in current block 904 may be predicted by projecting the location [x][y] in a direction specified by a given angular mode to a point on the horizontal or vertical line of samples comprising reference samples 902. The sample at location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x][y] in current block 904 for a vertical prediction mode 906 given by an angle q. For vertical prediction modes, the location [x][y] in current block 904 is projected to a point (referred to herein as the “projection point”) on the horizontal line of reference samples ref₁[x]. Reference samples 902 are only partially shown in FIG. 12 for ease of illustration. Because the projection point falls at a fractional sample position between two reference samples in the example of FIG. 12, the predicted sample p[x][y] in current block 904 may be calculated by linearly interpolating between the two reference samples as follows

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] \qquad ( 7 )$$

where iᵢ is the integer part of the horizontal displacement of the projection point relative to the location [x][y] and may calculated as a function of the tangent of the angle φ of the vertical prediction mode 906 as follows

$${i}_{i} = ⌊ ( y + 1 ) \cdot tan φ ⌋ , \qquad ( 8 )$$

and i_{f} is the fractional part of the horizontal displacement of the projection point relative to the location [x][y] and may be calculated as

$${i}_{f} = ( ( y + 1 ) \cdot tan φ ) - ⌊ ( y + 1 ) \cdot tan φ ⌋ . \qquad ( 9 )$$

where └·┘ is the integer floor.

For horizontal prediction modes, the position [x][y] of a sample in current block 904 may be projected onto the vertical line of reference samples ref₂[y]. Sample prediction for horizontal prediction modes is given by:

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] \qquad ( 10 )$$

where iᵢ is the integer part of the vertical displacement of the projection point relative to the location [x][y] and may be calculated as a function of the tangent of the angle φ of the horizontal prediction mode as follows

$${i}_{i} = ⌊ ( x + 1 ) \cdot tan φ ⌋ , \qquad ( 11 )$$

and i_{f} is the fractional part of the vertical displacement of the projection point relative to the location [x][y] and may be calculated as

$${i}_{f} = ( ( x + 1 ) \cdot tan φ ) - ⌊ ( x + 1 ) \cdot tan φ ⌋ . \qquad ( 12 )$$

where └·┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1-if) and if. In the above angular intra prediction examples, the predicted sample p[x][y] may be calculated with some predefined level of sample accuracy, such as 1/32 sample accuracy. For 1/32 sample accuracy, the set of two-tap FIR interpolation filters may comprise up to 32 different two-tap FIR interpolation filters—one for each of the 32 possible values of the fractional part of the projected displacement if. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on if, similar to the two-tap FIR filter. For 1/32 sample accuracy, a set of 32 different four-tap FIR filters may comprise up to 32 different four-tap FIR filters-one for each of the 32 possible values of the fractional part of the projected displacement i_{f}. In other examples, different levels of sample accuracy may be used. The set of four-tap FIR filters may be stored in a look-up table (LUT) and referenced based on if. The value of the predicted sample p[x][y], for vertical prediction modes, may be determined based on the four-tap FIR filter as follows:

$$p [ x ] [ y ] = {\sum }_{i = 0}^{3} fT [ i ] * ref [ x + iIdx + i ] \qquad ( 13 )$$

where ft [i], i=0 . . . 3, are the filter coefficients. The value of the predicted sample p[x][y], for horizontal prediction modes, may be determined based on the four-tap FIR filter as follows:

$$p [ x ] [ y ] = {\sum }_{i = 0}^{3} fT [ i ] * ref [ y + iIdx + i ] , \qquad ( 14 )$$

It should be noted that supplementary reference samples may be constructed for the case where the position [x][y] of a sample in current block 904 to be predicted is projected to a negative x coordinate, which happens with negative vertical prediction angles q. The supplementary reference samples may be constructed by projecting the reference samples in ref₂[y] in the vertical line of reference samples 902 to the horizontal line of reference samples 902 using the negative vertical prediction angle q. Supplemental reference samples may be similarly for the case where the position [x][y] of a sample in current block 904 to be predicted is projected to a negative y coordinate, which happens with negative horizontal prediction angles. The supplementary reference samples may be constructed by projecting the reference samples in ref₁[x] on the horizontal line of reference samples 902 to the vertical line of reference samples 902 using the negative horizontal prediction angle q.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction mode as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

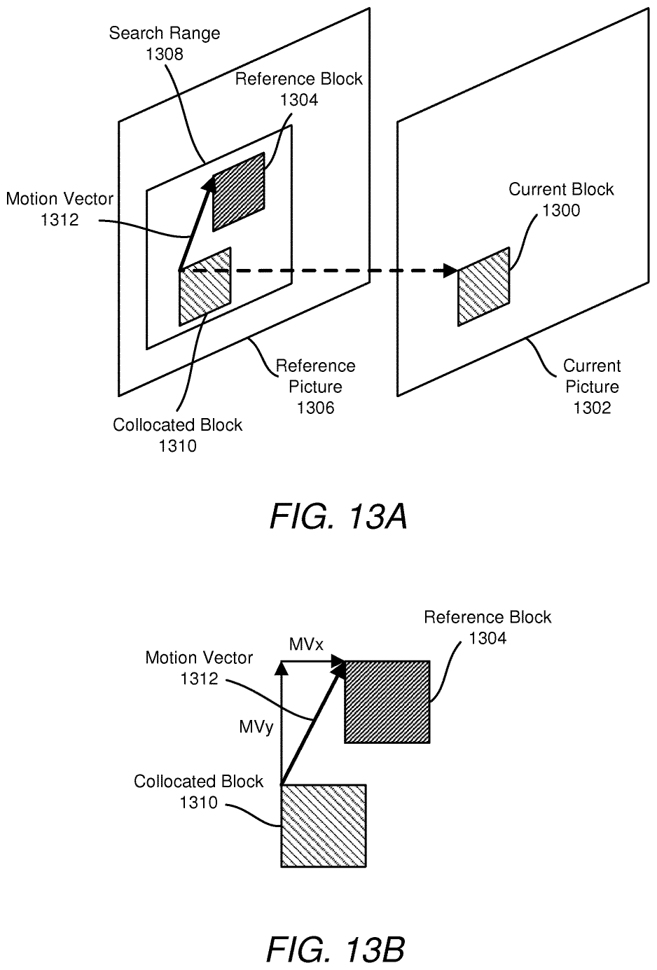

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have ½, ¼, ⅛, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

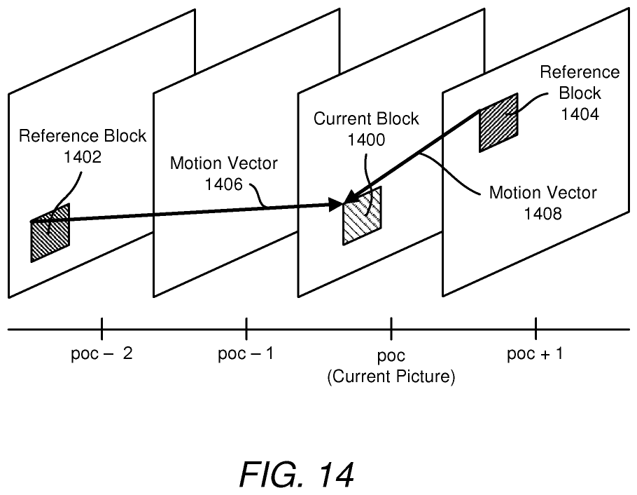

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1402 is in a picture that proceeds the current picture of current block 1400 in terms of POC. In other examples, the reference pictures may both precede or proceed the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index, into the reference picture list, of the reference picture comprising reference block 1402. In other instances, the motion information for reference block 1402 may include an indication of motion vector 1406 and an indication of the reference index, into the reference picture list, of the reference picture comprising reference block 1402. The motion information for reference block 1404 may include motion vector 1408 and the reference index, into the reference picture list, of the reference picture comprising reference block 1404. In other instances, the motion information for reference block 1404 may include an indication of motion vector 1408 and an indication of the reference index, into the reference picture list, of the reference picture comprising reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bitstream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. For example, for a motion vector represented by a horizontal component (MVx) and a vertical displacement (MVy) relative to the position of the current block being coded, the MVD may be represented by two components calculated as follows:

$${MVD}_{x} = {MV}_{x} - {MVP}_{x} \qquad ( 15 )$$

$${MVD}_{y} = {MV}_{y} - {MVP}_{y} \qquad ( 16 )$$

where MVDₓ and MVD_{y} respectively represent the horizontal and vertical components of the MVD, and MVPₓ and MVP_{y} respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

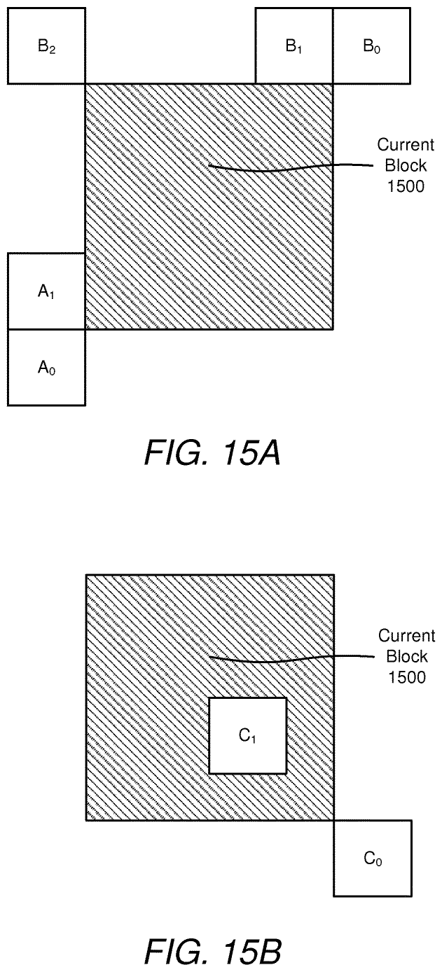

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bitstream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and VVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

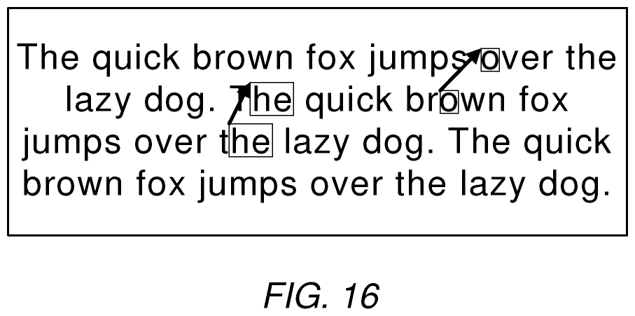

HEVC and VVC both include a prediction technique to exploit the correlation between blocks of samples within the same picture of screen content video. This technique is referred to as intra block copy (IBC) or current picture referencing (CPR). Similar to inter prediction, an encoder may apply a block matching technique to determine a displacement vector (referred to as a block vector (BV) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bitstream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may represented by two components calculated as follows:

$${BVD}_{x} = {BV}_{x} - {BVP}_{x} \qquad ( 17 )$$

$${BVD}_{y} = {BV}_{y} - {BVP}_{y} \qquad ( 18 )$$

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂.

The most probable mode (MPM) refers to the intra prediction mode that is most likely to be the best mode for the current block being encoded or decoded. In current intra prediction techniques, the MPM is determined by analyzing the intra prediction modes of the neighboring CUs. VVC uses a list of 6 MPMs (referred to as the “MPM list”) for luma intra prediction. The MPM list is derived from the intra prediction modes of the neighboring CUs, and is updated as the encoder progresses through the video frame. When encoding a block, the encoder may first check if the current block is a candidate for any of the MPMs in the MPM list. If it is, the encoder then compares the prediction errors of the respective MPMs to determine which MPM from the MPM list is the best mode for the current block. If the current block is not a candidate for any of the MPMs in the MPM list, the encoder may then evaluate all intra prediction modes (e.g., 67 in VVC) to determine the best mode for the current block.

The use of MPMs can significantly improve the coding efficiency of VVC. This is because the encoder does not need to signal the intra prediction mode for the current block if it is one of the MPMs. Instead, the decoder can infer the intra prediction mode for the current block from the corresponding MPM list.

Three types of intra modes are considered to construct the MPM list: default intra modes; neighboring intra modes; and derived intra modes. A unified 6 MPM list is used for intra blocks irrespective of whether Multiple Reference Lines (MRL) and Intra Sub-Partitions (ISP) coding tools are applied. The MPM list for the current block is constructed based on intra modes of the left neighbor block and the above neighbor block of the current block. Suppose the mode of the left neighbor block is denoted as Left and the mode of the above neighbor block is denoted as Above, the unified MPM list may be constructed as follows: when a neighboring block is not available, its intra mode is set to planar mode by default; if both modes Left and Above are non-angular modes, then the MPM list is set to include {planar, DC, V, H, V−4, V+4}, where “V” and “H” refer to vertical mode and horizontal mode, respectively; if one of modes Left and Above is an angular mode, and the other is non-angular, set a mode Max as the larger mode in Left and Above, and set MPM list to include {planar, Max, Max−1, Max+1, Max−2, Max+2}; if Left and Above are both angular and they are different, set a mode Max and a mode Min as the larger mode in Left and Above and as the smaller mode in Left and Above, respectively, and thereafter, if Max-Min is equal to 1, then set MPM list to include {planar, Left, Above, Min−1, Max+1, Min−2}, if Max-Min is greater than or equal to 62, then set MPM list to include {planar, Left, Above, Min+1, Max−1, Min+2}, if Max-Min is equal to 2, set MPM list to include {planar, Left, Above, Min+1, Min−1, Max+1}, or otherwise, set MPM list to include {planar, Left, Above, Min−1, −Min+1, Max−1}; and if Left and Above are both angular and they are the same, set MPM list to include {planar, Left, Left−1, Left+1, Left−2, Left+2}.

The encoder may encode an MPM index in the bitstream to indicate the position of the selected intra prediction mode in the MPM list to the decoder. The decoder may derive the MPM list in a manner identical to the encoder, and use the MPM index obtained from the bitstream to obtain the intra prediction mode from the MPM list derived at the decoder. In some instances, the first bin of the MPM index codeword is CABAC context coded so as to achieve additional coding efficiencies. Three contexts are used, corresponding to whether the current intra block is MRL enabled, ISP enabled, or a normal intra block.

During the 6 MPM list generation process, pruning can be used to remove duplicated modes so that only unique modes may be included into the MPM list. For entropy coding of the 61 non-MPM modes (that is, the 67 modes in VVC minus the 6 MPM), a truncated binary code (TBC) can be used.

In some implementations, the MPM list is extended to include 16 additional candidates, and is divided into two parts, the primary MPM (PMPM) (6 entries) and the secondary (SMPM) (16 entries). In some implementations, the first entry in the general MPM list is the planar mode. The remaining entries are composed of the intra modes of the adjacent neighboring blocks corresponding to positions left (L), above (A), below-left (BL), above-right (AR), and above-left (AL) (e.g., shown in FIG. 15A as A1, B1, A0, B0, and B2), and decoder-side intra mode derivation (DIMD) modes which are sorted in ascending order of a cost such as, for example, SAD, SSD, SATD, etc. Up to 5 modes with the smallest costs are added to the MPM list. The cost is computed between the prediction and the reconstructed samples of the template of the current block. Sorted directional modes are added into the general MPM list, and then the default modes, until the general MPM list with 22 entries is constructed. In some examples, if a CU block is vertically oriented, the order of neighboring blocks corresponds to A, L, BL, AR, AL; otherwise, it is L, A, AL, AR, BL.

Intra template matching prediction (IntraTMP) is a special intra prediction mode that copies the best prediction block from the reconstructed part of the current frame, whose template (e.g., an L-shaped template, above only template, or left-only template) matches the current template (i.e., the L-shaped template, above only template, or left-only template of the current block). For a predefined search range, the encoder searches for the most similar template to the current template in a reconstructed part of the current frame and uses the corresponding block as a prediction block. The SAD cost, or another cost measure (e.g., SSD, SATD), may be used as a cost function to evaluate similarity. The encoder then signals the usage of this mode, and the same prediction operation is performed at the decoder.

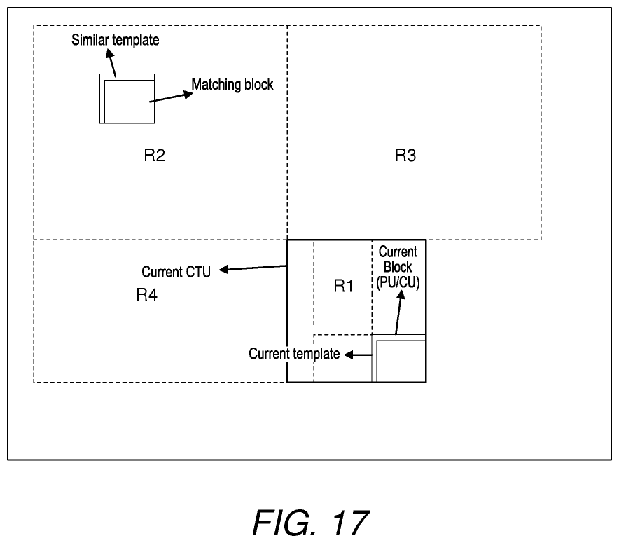

The prediction for the current block is generated by matching the L-shaped, top-only, or left-only causal neighbor of the current block with another block in a predefined search area shown in FIG. 17 consisting of the current CTU (R1), the top-left CTU (R2), the above CTU (R3), and the left CTU (R4).

Within each region R1-R4, the decoder constructs a candidate list of up to a predetermined maximum (e.g., 19) template matching block vectors that are ranked in ascending order according to the template cost (e.g., SAD costs). The following modes are supported: single predictor, fusion of multiple predictors, sub-pel precision, and linear filter model. In the single predictor mode, a single predictor is selected from the candidate list. In the fusion of multiple predictors mode, multiple predictors are blended to derive the final prediction block. The blending weights are either computed from the template matching cost of each predictor, or with a Wiener-filter based weight derivation method. In the sub-pel precision mode, when a single predictor is used, sub-pel precision can be used with ½-pel precision, ¼-pel precision and ¾-pel precision, each with 8 possible directions. In the linear filter model mode, a linear filter can be learned between the reference template and current template and be applied to the reference block. This mode can be used for the single predictor when sub-pel precision is not used.

The dimensions of the regions, specifically the width and height of the search ranges (SearchRange_w, SearchRange_h), are set proportional to the block dimension (BlkW, BlkH) to have a fixed number of cost comparisons per pixel. That is: SearchRange_w=min (64, a*BlkW); and SearchRange_h=min (64, a*BlkH), where “a” is a constant that controls the gain/complexity trade-off. In practice, “a” may be set equal to 5.

To speed-up the template matching process, the search range of all search regions is subsampled by a factor (e.g., factor of 3). After finding the best match, a refinement process is performed. The refinement is done via a second template matching search around the best match with a reduced range.

The IntraTMP tool is enabled for CUs with size less than or equal to 64 in width and height. This largest CU size for IntraTMP is configurable. The IntraTMP prediction mode is signaled at CU level through a dedicated flag when DIMD is not used for current CU.

Decoder-side Intra Mode Derivation (DIMD) is an intra coding mode where the intra prediction mode is not transmitted in the bitstream (after being determined by the encoder, for example, by a rate distortion optimization (RDO) algorithm) but is derived by using a gradient analysis of neighbor reconstructed pixels. That is, with DIMD, the intra prediction mode is implicit at the decoder. DIMD is signaled with a flag and the intra prediction mode is derived during the reconstruction process at the decoder in a manner that is identical to the manner in which the intra prediction mode is derived at the encoder. If DIMD is not selected at the encoder as the intra coding mode for the current block, the intra prediction mode may be parsed from the bitstream at the decoder as in an intra coding mode process that signals the intra prediction mode in the bitstream.

In DIMD, a 3-samples wide (in width or height) template area (composed of left, above, and above-left areas) of the current block is defined in which edge detection filters (e.g., 3×3 horizontal and vertical Sobel filters) adjacent to the current block are applied on all 3×3 window positions centered on the pixels of the middle line of the template area in order to determine the amplitude and the angle of luminance direction (orientation) for each middle line sample of the template area. A histogram of gradients (HoG) is computed where each entry in the HoG corresponds to a respective conventional intra angular mode. For example, where Gₕₒᵣ and Gᵥₑᵣ are the intensities of pure horizontal and vertical directions, respectively, as calculated using a Sobel filter at one 3×3 window position, an angle is calculated for the window as angle=arctan (Gₕₒᵣ/Gᵥₑᵣ). The calculated angle is converted into one of the angular intra prediction modes (e.g., one of the 65 angular intra prediction modes in VVC), and the corresponding amplitude (i.e., the amplitude for the window position) amplitude=|Gₕₒᵣ|+|Gₕₒᵣ| is added to the HoG indexed by the respective intra prediction modes. Thus, when all window positions in the template area are calculated, each entry in the HoG represents the cumulated amplitude for a respective intra prediction mode.

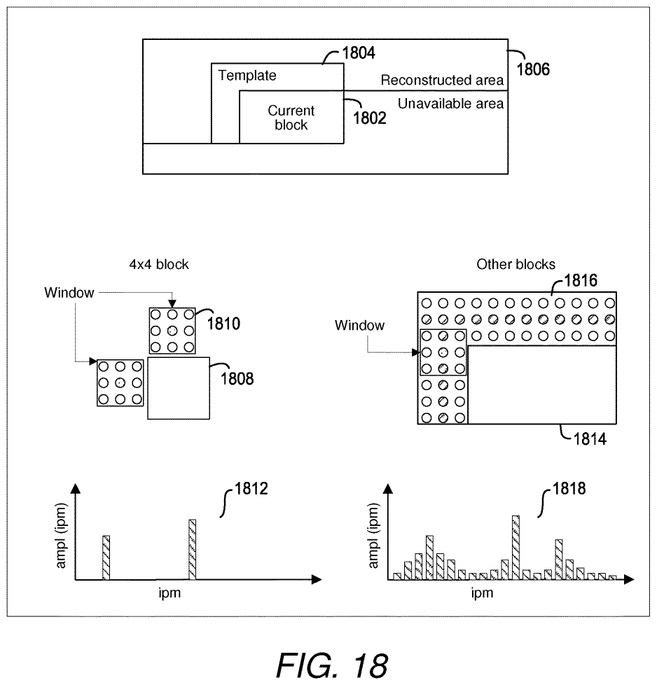

FIG. 18 illustrates an example of DIMD template zone for computing a HoG in accordance with some embodiments. The reconstructed area 1806 relative to the current block 1802 is shown, as is an L-shaped template 1804 of the current block 1802. It should be understood that the shape of this template may not necessarily be L-shaped and may be, e.g., a top template (e.g., including samples above the current block 1802) or a left template (e.g., including samples to the left of the current block 1802). An example 4×4 pixel square current block 1808 is shown with a 3×3 window 1810 in the template area. The HoG 1812 is the histogram corresponding to current block 1808. Another example is the rectangular current block 1814 with a 3-pixel deep template area 1816. The HoG 1818 corresponds to the rectangular current block 1814. As illustrated, each coordinate position on the x-axis of the illustrated HoG is a respective intra prediction mode (IPM), and the y-axis represents the cumulative amplitude for the respective intra prediction modes.

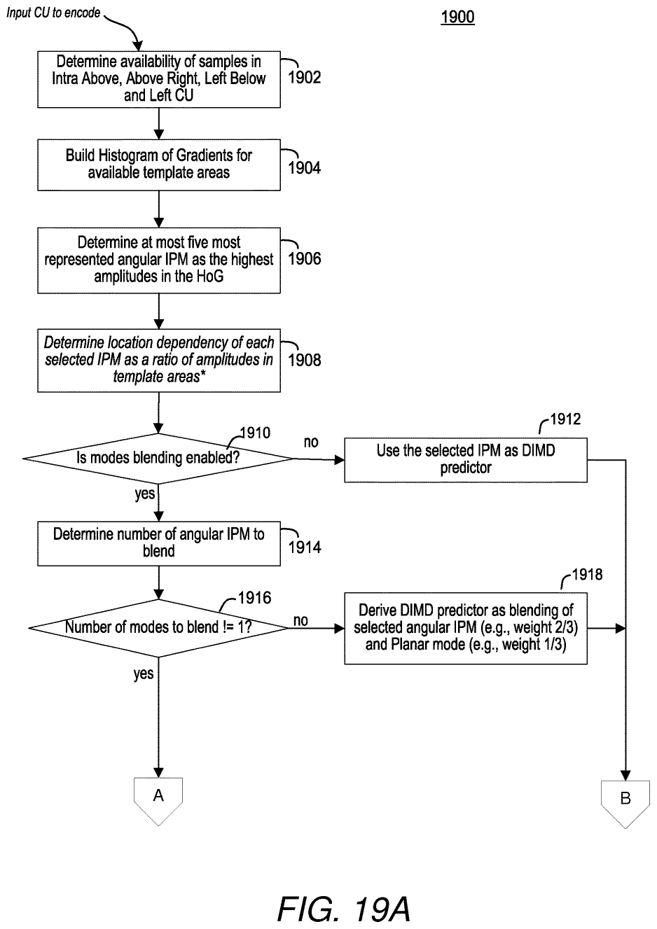

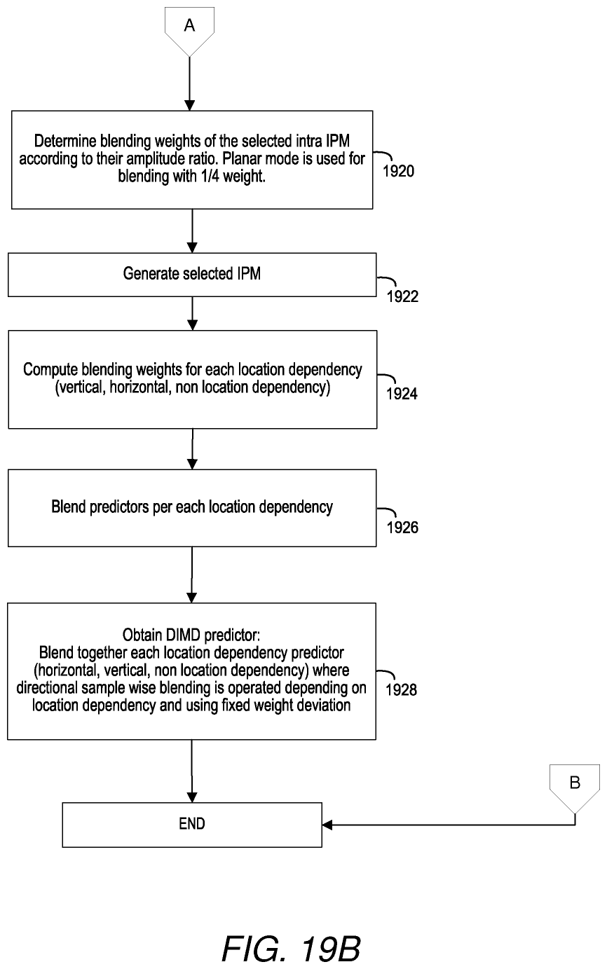

FIGS. 19A and 19B illustrate a flowchart 1900 of an example DIMD predictor derivation process. Operations of flowchart 1900 may be implemented (e.g., performed) reciprocally by an encoder (e.g., encoder 200 in FIG. 2) and/or a decoder (e.g., decoder 300 in FIG. 3).

At 1902, the availability of samples in a template area, for example, in the CUs above, above right, left below and left of the current block is determined. For example, the template area may be an example L-shaped template 1804 for a current block 1802 shown in FIG. 18. At 1904, the HoG for available template areas is constructed. HoG construction for template areas is described above in relation to FIG. 18. At 1906, up to a predetermined number (e.g., 5) of the most represented intra prediction modes are identified based on the highest amplitudes in the HoG. At 1908, the location dependency of each identified intra prediction mode is determined as a ratio of amplitudes in template areas. In some implementations, the location dependency of an identified intra prediction mode can be determined as follows: default location dependency is set to 0 (i.e., no location dependency); if the intra prediction mode's amplitude in the left template (the sum of amplitudes for the identified intra prediction mode from samples in the template area to the left of the current block) is less than the intra prediction mode's average amplitude among all templates (e.g., among three template regions-left template, above template, and above left template), then the location dependency is set to 1 (vertical); else if the intra prediction mode's amplitude in the above template is less than the intra prediction mode's average amplitude among all templates, then the location dependency is set to 2 (horizontal). This calculation can be facilitated by, when generating the HoG, cumulating the amplitudes separately for each of the left template region, above template region, and above left template region in respectively different HoGs and then subsequently summing the three HoG to determine the combined HoG for the entire template area.

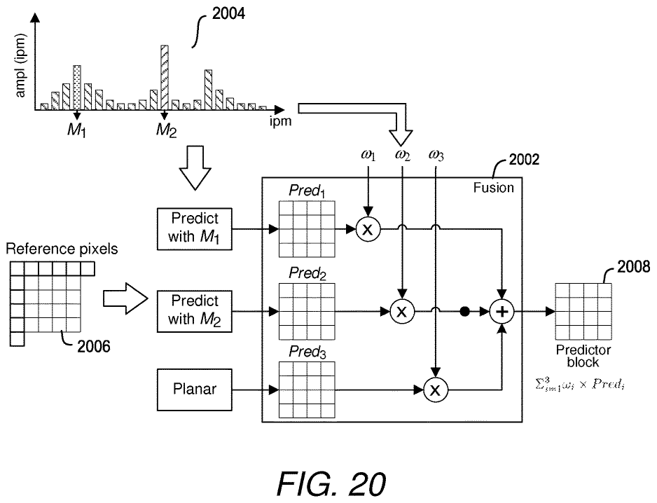

At 1910, it is determined whether mode blending is enabled. If mode blending is disabled, then at 1912 it is determined to use one of the identified intra prediction modes (e.g., corresponding to the highest amplitude) as the DIMD predictor. Alternatively, if it is determined at 1910 that mode blending is enabled, then at 1914, the number of angular intra prediction modes to be blended is determined. Mode blending may be enabled, for example, when the first and second identified intra prediction modes are both angular modes. At 1916, it is determined whether the number of modes to blend is greater than 1. If the number of modes to blend is not greater than 1, then at 1918, the DIMD predictor is determined by blending the one identified angular intra prediction mode and the planar mode (e.g., in weights ⅔ and ⅓, respectively). If at 1916, it is determined that the number of modes to be blended is more than 1, then at 1920, blending weights of the identified intra prediction modes are determined according to their amplitude ratios. The planar mode can be used for the blending with, for example, a ¼ weight. At 1922, the selected intra prediction mode, is generated as the result of the blending of the identified intra prediction modes and the planar mode. As described below in relation to FIG. 20, the blending of identified intra prediction modes and the planar mode to derive the selected intra prediction mode for the current block may include computing all the identified intra prediction modes and the planar mode using neighboring reconstructed samples.

In some implementations, the selected intra prediction mode determined at 1922 is used as the DIMD predictor for the current block.

Alternatively, some implementations may further use location-dependent blending modes to derive the DIMD predictor. The blending weights determined at 1920 are uniformly applied to all samples in the predictor and may be referred to as “uniform weights”. For location-dependent blending, for example, at 1924, sample-based weights for a predictor (e.g., for each identified DIMD intra prediction mode) are computed so that the average weight used within the block is approximately equal to the corresponding uniform weight (e.g., calculated at 1920) and so that higher weights are used in the portion of the block closer to the left template region or the above template region, depending on the location dependency of the DIMD intra prediction mode. A range is pre-defined, corresponding to the largest deviation of sample-based weights from the corresponding uniform weight. Higher values of the pre-defined range result in a higher variation of the weights within the block. After the blending weights for each location dependency (e.g., vertical, horizontal, no location dependency) are calculated at 1924, at 1926, predictions per each location dependency are blended. For example, for each of horizontal location dependency, vertical location dependency and no location dependency (i.e., diagonal location dependency) that is used by any of the identified intra prediction modes of the DIMD predictor, the identified intra prediction modes having that location dependency are blended based on their respective amplitudes. At 1928, the DIMD predictor is obtained by blending together the respective location dependency predictors (horizontal, vertical, no location dependency), in accordance with the respective sums of amplitudes of the identified intra prediction modes in each location dependency. This provides a directional sample-wise blending depending on location dependency and using fixed weight deviation as calculated at 1924.

In example implementations, the DIMD intra prediction mode determined at 1922 or 1928 may be added to a MPM list along with other intra prediction modes being considered for use on the current block. Subsequently, if it is determined, by a rate distortion cost calculation or the like, that the DIMD intra prediction mode is the best (i.e., most cost effective) intra prediction mode, then the current block is encoded using the DIMD intra prediction mode and only a flag indicating that the current block is encoded using DIMD is transmitted on the bitstream with the residual of the current block. The intra prediction mode is not transmitted in the bit stream.

In example implementations, up to a predetermined number (e.g., 4) angular intra prediction modes are selected from the HoG and are combined (for example, as described in relation to 1920 or 1928 above) with the planar mode with weights derived from the selected angular intra prediction amplitudes' ratio (e.g., with planar having a ratio of ¼ i.e., 16/64 with 6 bits integer precision). An example combining (also referred to as “fusion” or “blending”) of angular intra prediction modes from the HoG is shown in FIG. 20. In FIG. 20, the blending of two angular intra prediction modes and the planar mode is shown. Intra prediction modes M1 and M2 are selected for the current block 2006 based on the highest two peaks of the HoG 2004. The predicted block 2008 for the current block 2006 is determined in a combining (fusion) operation 2002 that combines predictions based on intra modes M1 and M2 and the planar mode, based on weights w1, w2 and w3. The weights before the respective angular intra prediction modes are determined according to the amplitudes of the corresponding gradients in the histogram and a predetermined weight can be used for the planar mode.

Since derived intra modes are included into the MPM list, the DIMD process is performed before the MPM list is constructed. The primary derived intra prediction mode of a DIMD block is stored with a block and is used for MPM list construction of the neighboring blocks. When DIMD is signaled, MPM and MRL—assumed to be 0—are not signaled.

Template-based intra mode derivation (TIMD) is a recently proposed intra coding mode, where a template zone in the reconstructed part of the current frame is set and used to derive the intra prediction mode for the current block. In the TIMD mode, the intra prediction mode is not transmitted in the bitstream (after determination by the encoder, for example, by a rate distortion optimization algorithm) but only the usage of TIMD is signaled, thereby saving intra prediction mode signaling bits. More specifically, TIMD usage is signaled with a flag at the CU level and the TIMD-derived intra prediction mode, when TIMD is enabled, is derived during the reconstruction process identically at the encoder and decoder. If TIMD is not selected at the encoder, the intra mode may be parsed from the bitstream at the decoder as in intra modes where the intra prediction mode is signaled in the bitstream.

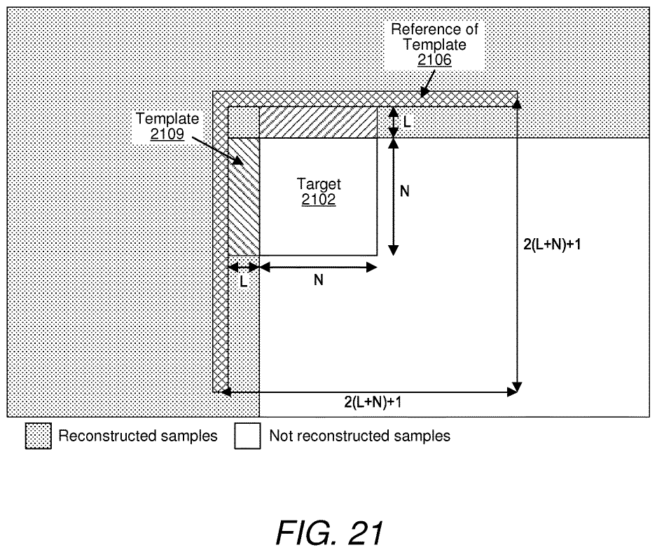

For each intra prediction mode in the MPM list, the SATD cost (or the SAD, SSD cost) between the prediction and reconstruction samples of a template is calculated. The intra prediction mode with the minimum cost is selected as the TIMD mode and used for intra prediction of the current block. In TIMD, either a 2-samples or 4-samples wide (in width or height) template area (composed of left, above, above-left areas) is defined. Reference samples of the templates are used to derive a predictor for the template area. FIG. 21 shows an example of a current block 2102 of N×N pixels, with a template 2109 of L-pixel width and corresponding reference samples 2106 of the template.

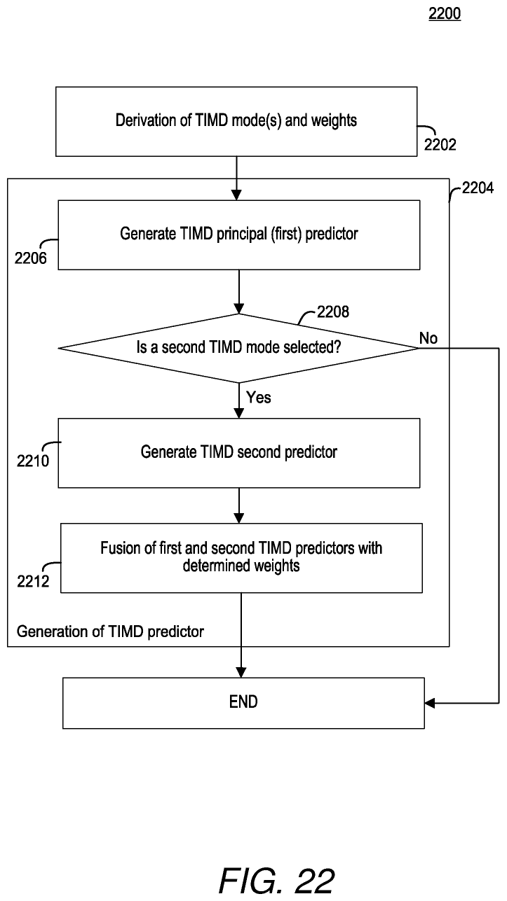

An example TIMD process 2200 may include an operation 2202 for deriving TIMD modes and weights and an operation 2204 for generating a TIMD predictor, as shown in FIG. 22. Operations of TIMD process 2200 may be implemented (e.g., performed) reciprocally by an encoder (e.g., encoder 200 in FIG. 2) and/or a decoder (e.g., decoder 300 in FIG. 3). A list of candidates' intra prediction modes is set (e.g., mainly consisting of MPM list possibly augmented with DC, horizontal and vertical modes) and each candidate mode is checked as an intra prediction of the template using a cost function (e.g., SAD, SSD or SATD) which computes a template matching score between the reconstructed samples in the template and the predicted samples of the template. At 2204, the two intra prediction modes that yield minimum cost are selected (see 2206, 2208, and 2210) for a refinement where the angular mode range is extended from 67 to 131 modes and the two adjacent modes (i.e. +/−1) of each selected intra prediction mode are checked. Then, at 2212, the selected candidates are selected as the two TIMD modes. Eventually, the two TIMD modes are blended with weights determined from their respective costs to generate the TIMD predictor.

Another recent intra mode prediction technique proposes to merge the DIMD HoG information from neighboring blocks in order to predict the current block. When neighboring blocks encoded with DIMD are available, the DIMD histograms of the selected neighboring CUs are combined to form a merged histogram of gradients (MHoG) for the current block. DIMD modes and weights are derived from this merged histogram. The HoG of current block is not used in the construction of the MHoG.

The DIMD merge process is similar to the DIMD process that is described above in relation to FIGS. 19A-B, and may only differ from that process by including a set of operations that precedes 1910. In the proposed DIMD HoG merge process, at most 3 neighboring CUs are selected from up to 13 neighboring CUs that are available, coded as intra DIMD, and are spatially the closest to the current block. The HoG or merged HoG of the selected neighbor CUs are retrieved. A merged HoG is calculated from the HoG (or merged HoG) of the selected CUs. The blended modes are identified depending on the merged HoG in the same manner as described above in relation to DIMD. Up to 5 intra prediction modes are selected (e.g., based on the highest amplitudes in the merged HoG), as in the regular DIMD mode, and location dependency is determined. If multiple intra prediction modes are selected, the location dependency is set to 0 (diagonal), otherwise, the location dependency is set to the selected intra prediction mode's location dependency. The DIMD HoG merge mode intra prediction mode for the current block can be determined by combining the selected intra prediction modes.

In existing technologies, decoder-side intra mode derivation is attractive at least partly because it can reduce the amount of information that is required to be signaled from the encoder to the decoder. In previous DIMD techniques, however, the DIMD modes and weights are derived from the reconstructed neighbor samples (the template areas) by computing gradients that may be on a small 3×3 template size. This may often not yield the best neighbor since the further from the template area the current block samples are, the less likely it is that spatial correlation between template region and current block is high. Moreover, no operations are processed to improve the derived blended mode in existing DIMD techniques. As an example, operations on the HoG like pruning or merging peaks could add diversity in the derived blended mode that can be beneficial to provide a more accurate intra prediction.

Moreover, unlike some other intra modes, DIMD (see FIGS. 19A-B) does not reuse neighbor information. Still further, the DIMD HoG merge can be considered only when at least one neighbor uses the DIMD mode (or DIMD HoG Merge mode). As described above, the DIMD process is used by several intra prediction modes (e.g., especially non-angular modes, to retrieve direction information) and during the MPM derivation process, even if the neighbor mode is not DIMD. Using correlations between blocks can improve compression efficiency. Consequently, the DIMD information from neighbor CU can be further used to improve the intra mode efficiency.

Additionally, in the DIMD mode and in the DIMD HoG merge mode, combining HoG may dilute a neighbor's HoG relevance because no operation is processed on the HoG. The HoGs are combined without any weights (e.g., only amplitude averaging is used to derive the MHoG), or without processing operations (e.g., pruning, densification), and thus allows an irrelevant (or less relevant) neighbor's HoG to skew the MHOG, diluting the relevant mode's peak. Indeed, spatial correlation may be prominent but also could be irrelevant as the picture may include different spatial regions with distinct characteristics.

These drawbacks may result in compromising reliability and competitiveness of DIMD compared to other intra modes.

Embodiments of the present disclosure relate to an approach for improved DIMD that can yield a more optimal intra mode more reliably. These and other features of the present disclosure are described further below.

The intra prediction processes, which were described above, provide 67 intra prediction modes (Planar, DC and 65 angular directions) for each prediction block. A luma intra prediction mode is selected for a luma prediction block and a chroma intra prediction mode is selected for the chroma prediction blocks. Mode-dependent reference and prediction sample smoothing is applied to increase prediction efficiency and the intra prediction mode is coded using either one of the 6 most probable modes (MPM) or one of the 61 remaining modes. It is noted that 28 wide angular modes (for rectangular CU only) can be used in replacement of regular modes.

Example embodiments of this disclosure provide a technique for the decoder to efficiently derive the intra prediction mode to be applied to the current block without having it signaled from the encoder. More specifically, the technique combines benefits of DIMD and Inter Prediction Merge Modes to obtain a new efficient intra prediction mode referred to herein as the “DIMD merge mode.” Some embodiments of this disclosure provide enhancements to the DIMD merge mode.

For each CU predicted using the DIMD merge mode, embodiments include building a list of DIMD information and selecting one to be used to reconstruct the current block. This list, referred to as “list of DIMD merge candidates”, is built from the DIMD information from various spatial neighbors (neighbor blocks in the current frame). As noted above, DIMD is used in the generation of the MPM list, so the DIMD information may already be available for most of the intra neighbor CUs (e.g., spatial neighboring blocks). In some embodiments, such neighbor CUs may include those which used DIMD HoG merge.

An initial list of DIMD merge candidates can be constructed according to a given checking order (also referred as “inclusion order”) of respective DIMD merge candidate families, such as, for example, in the order of DIMD information of spatial adjacent candidates, DIMD information of spatial non-adjacent candidates, DIMD information of history-based spatial candidates, DIMD information of combined candidates, and/or default DIMD information candidates.

In some embodiments, the list of DIMD merge candidates may have a predetermined maximal number of DIMD merge candidates, and the generation process may be stopped when the maximal number is reached (e.g., when the list is full). Moreover, the generation of the list may ensure that no DIMD merge candidates with duplicate DIMD information is added to the list. The list generation process may also ensure that the number of DIMD merge candidates from each family of DIMD merge candidates does not exceed a predetermined maximal threshold.

In some embodiments, after the initial version of the list of DIMD merge candidates is constructed, the list can be reordered according to criteria, such as, for example, template matching-based reordering and/or direction-based reordering. Alternatively, a template matching-based reordering may be applied only to a part of the list of DIMD merge candidates. The template matching cost of a candidate's DIMD information during the reordering process may be measured by, for example, by the cost (e.g., SAD, SSD, SATD, etc.) difference between samples of a template of the current block and their corresponding reconstructed neighboring samples. The lower the template matching cost of a candidate, the more relevant the candidate is and the closer it is located towards the beginning of the list. Reordering the list may improve the encoding efficiency of the DIMD merge mode by selecting a smaller index that is more efficiently encoded. By reordering the list of DIMD merge candidates, it becomes more likely that the DIMD merge candidate selected by the encoder has a lower index, which may be more efficiently signaled.

Once the list is completed and (e.g., optionally) reordered, a DIMD merge candidate with the DIMD information that is best for the current block is selected. At the encoder, this selection may be based upon a rate distortion optimization (RDO) cost of the selected DIMD merge candidate. The selected DIMD merge candidate can be derived at the decoder in accordance with an indicator that is signaled by the encoder. This indicator indicates which entry of the list of DIMD merge candidates (i.e., which candidate from the constructed list) is to be used to process the block reconstruction. In the list of DIMD merge candidates, all DIMD information from spatial neighbor blocks needed to reconstruct the current block are stored, for example: the intra prediction modes to be blended, the corresponding blending weights, and location dependency information. This DIMD information defines a DIMD merge candidate and may be referred to as “DIMD parameters”. In some embodiments, additional information, such as, for example, HoG information may be included in the DIMD parameters.

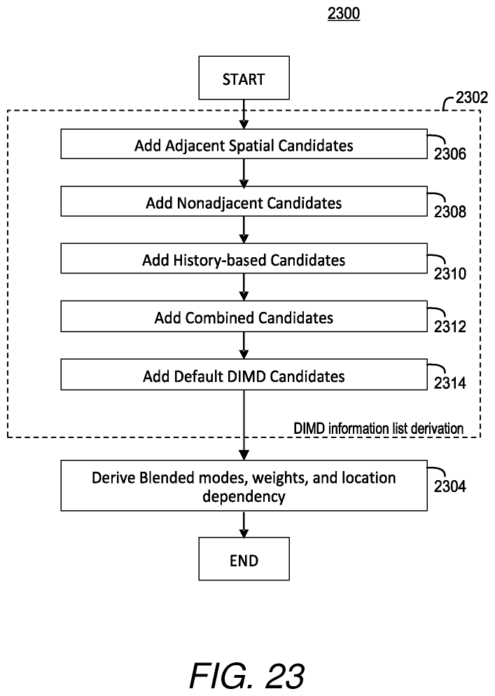

A flowchart 2300 of a method for the new intra prediction mode, DIMD merge mode, is shown in FIG. 23, according to some embodiments of the present disclosure. The method of flowchart 2300 comprises a DIMD merge information derivation operation 2302 and an operation 2304 to derive blended modes, weights, and location dependency. The method may be performed reciprocally by an encoder (e.g., encoder 200 in FIG. 2) or by a decoder (e.g., decoder 300 in FIG. 3).

The method begins at 2302. The DIMD merge information derivation at 2302 may include several operations such as 2306-2316 each of which may add to the list of DIMD merge candidates a family of DIMD merge candidates obtained from spatial neighbor blocks (i.e. intra blocks) of the current block that are selected based on a different selection criterion, from combinations of DIMD information already in the list, or from configured default DIMD information. In some embodiments, the DIMD merge candidates in the list of DIMD merge candidates is arranged as a list or table, but embodiments may not be limited by a specific arrangement structure of the DIMD merge candidates.

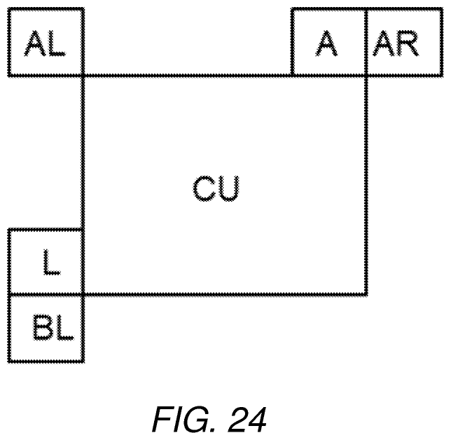

At 2306, DIMD merge candidates from a family of spatial adjacent blocks is considered for adding DIMD merge candidates to the list of DIMD merge candidates. FIG. 24 illustrates adjacent neighbor samples of blocks in the family of spatial adjacent blocks. In some embodiments, the DIMD merge candidates from spatial adjacent blocks can be added to the list of DIMD merge candidates according to the inclusion order of blocks corresponding to left sample (L), above sample (A), above left sample (AL), above right sample (AR), and bottom left sample (BL). In some embodiments, another inclusion order such as, L, A, AR, BL, and AL, or yet another different inclusion order may be used. The blocks in the family of spatial adjacent blocks are also considered in the derivation of the MPM list. Between 1 and 5 (all spatial adjacent neighbors) candidates may be added to the DIMD merge candidate list at 2306. For the DIMD information of a particular spatial block to be included in the DIMD merge candidate list, that block must at least already have had (i.e., during the reconstruction of blocks in the current frame) DIMD information derived for that block. DIMD information may be derived for a block for DIMD or another intra prediction mode that uses the DIMD parameters such as, for example, DIMD HoG merge mode, DIMD merge mode, and MPM list derivation. In some embodiments, a merge candidate is added to the list of DIMD merge candidates only if the corresponding neighbor block was encoded or decoded based on DIMD or another intra prediction mode that uses the DIMD parameters. In some instances, such as when none of the adjacent spatial adjacent blocks are reconstructed using DIMD mode, DIMD HoG merge mode, or DIMD merge mode, or had derived DIMD information, 2306 may not add any candidates to the list of DIMD merge candidates.

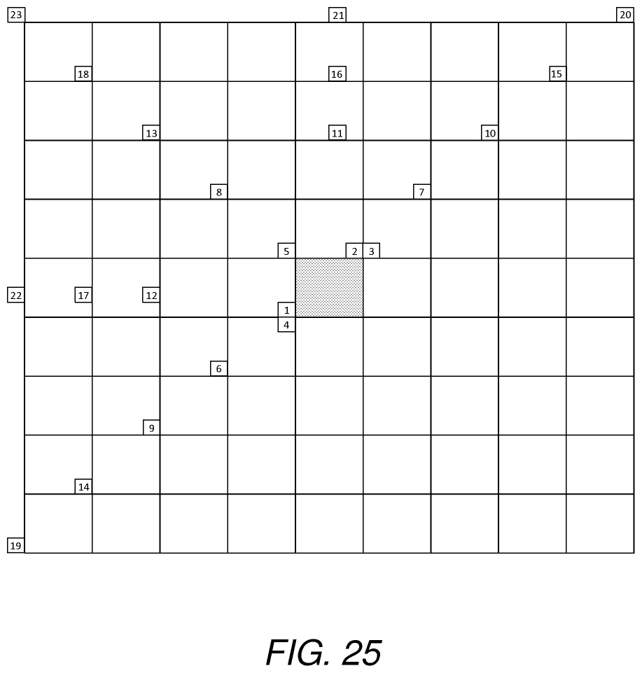

At 2308, DIMD merge candidates from a family of spatial non-adjacent blocks of the current block are added to the list of DIMD merge candidates. The positions and inclusion order of the DIMD merge candidates of non-adjacent candidates in the same frame as the current block may be in accordance with a predetermined sequence, such as that, for example, shown in FIG. 25. The pattern and sequence of blocks indicated in FIG. 25 is the same as that defined in some implementations for inter-merge prediction candidates.

The numbers 1-5 shown in FIG. 25 refer to spatially adjacent neighbors of the current block (shown shaded) in the inclusion order L, A, AR, BL, and AL, that were already added to, or otherwise considered for inclusion in, the merge candidate list at 2306 and thus may not be considered at 2308. The sequence of blocks indicated by the numbers 6-23 may be considered for inclusion of the corresponding DIMD information in the list of DIMD merge candidates at 2308. As can be seen in FIG. 25, the non-adjacent neighbors 6-23 considered for inclusion in the list of DIMD merge candidates at 2308 are arranged in the frame along the left horizontal direction, the above vertical direction, the above left diagonal direction, the above right diagonal direction, and below right diagonal direction.

For the DIMD information of a particular spatial non-adjacent block to be included in the list of DIMD merge candidates, that block must have had DIMD used for encoding/decoding or at least have had DIMD information derived for that block. DIMD information may be derived for a block for encoding/decoding based on DIMD or another intra prediction mode that uses the DIMD parameters such as, for example, DIMD HoG merge mode, DIMD merge mode, and MPM list derivation. In some embodiments, a candidate is added to the list of DIMD merge candidates only if the corresponding neighbor block was reconstructed based on DIMD or another intra prediction mode that uses the DIMD parameters. In some instances, such as when none of the adjacent spatial candidates were encoded/decoded using DIMD, DIMD HoG merge, or DIMD merge, or had derived DIMD information, 2308 may not add any candidates to the list of DIMD merge candidates.

At 2310, a family of merge candidates from a history-based table of DIMD information are added to the list of DIMD merge candidates. The history-based table may be maintained to include recently used DIMD information of intra blocks. This history-based table can be updated each time a CU intra prediction mode uses the DIMD process, i.e., when the DIMD information is derived (e.g., a block using the DIMD mode, or an MPM-based mode, or based on a direction derived from DIMD, or a DIMD HoG merge mode, or DIMD merge mode). This table includes a limited number of entries of DIMD information from previous blocks and does not include any duplicate DIMD information.

For the DIMD information of a particular spatial block to be included in the history-based table, that block must have had DIMD used for encoding/decoding or at least have had DIMD information derived for that block. DIMD information may be derived for a block for encoding/decoding based on DIMD or another intra prediction mode that uses the DIMD parameters such as, for example, DIMD HoG merge mode, DIMD merge mode, and MPM list derivation. In some embodiments, an entry of DIMD information is added to the history-based table only if the corresponding neighbor block was reconstructed based on DIMD or another intra prediction mode that uses the DIMD parameters. In some embodiments, since example embodiments may separately consider spatial adjacent blocks and spatial non-adjacent blocks in accordance with a predetermined inclusion order, only DIMD information of spatial blocks that are neither spatial adjacent blocks nor spatial non-adjacent blocks according to the predetermined inclusion pattern are added to the history-based table.

When inserting a new entry of DIMD information into the history-based table, a constrained first-in-first-out (FIFO) rule may be utilized where a redundancy check is first applied to determine whether there is identical DIMD information in the table. If found, the entry with the identical DIMD information is removed from the table and all entries following that in the table are moved forward in the FIFO order, and the new DIMD information is inserted as the last entry. The table could be reset at intervals, such as, for example, at the beginning of each CTU row. Such resetting may be performed due to hardware constraints. Such resetting may also help ensure that only the most recent neighbor blocks are in the table. The history-based table of DIMD information used in embodiments may in some aspects be similar to the history-based table of motion vectors (HMVP) in the whole-block-based Advanced Motion Vector Predictor (AMVP) mode for inter prediction in VVC.

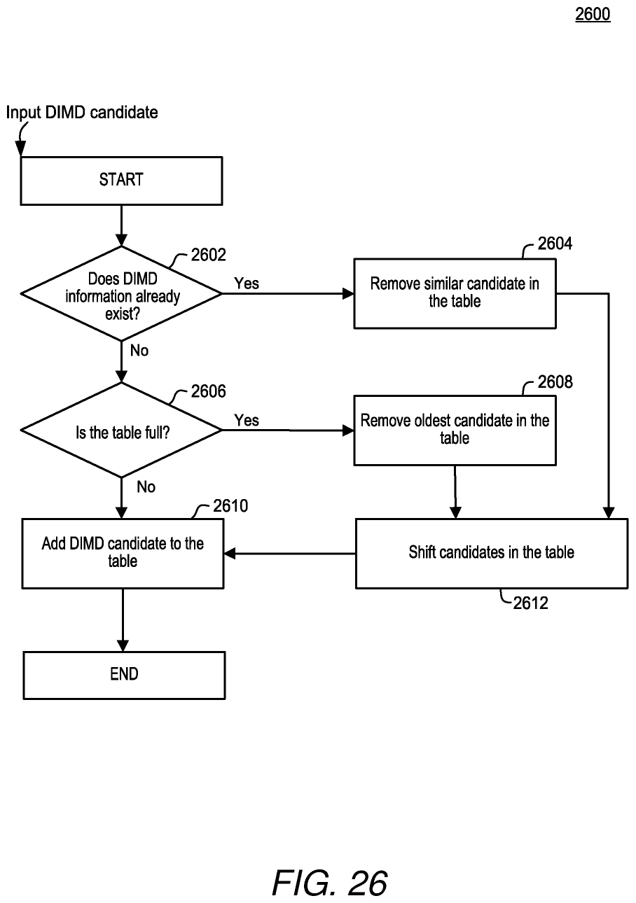

FIG. 26 is a flowchart 2600 of a method for adding DIMD information to the history-based table, according to some embodiments. Operations of flowchart 2600 may be performed reciprocally by an encoder (e.g., encoder 200 in FIG. 2) or by a decoder (e.g., decoder 300 in FIG. 3).

The method of flowchart 2600 begins at 2602 upon considering the DIMD information of a DIMD merge candidate for input to the history-based table. Such a consideration may occur whenever a spatial neighbor block uses DIMD or other intra mode in which DIMD information is derived. At 2602, it is determined whether the DIMD information to be added already exists in the table. If, at 2602, it is determined that the DIMD information to be added is not in the table, then at 2606, it may be determined whether the table is full. This determination may be based on a preconfigured maximum size threshold for the history-based table. If the table is not full, at 2610, the DIMD information to be added is added to the history-based table.

If at 2602, it is determined that the DIMD information to be added is in the table, then at 2604, the duplicate DIMD information already in the table is removed from the table.

If at 2606 it is determined that the history-based table is full, at 2608, the oldest entry in the table is removed.

After either 2604 or 2608, at 2612, the entries that follow the removed entry in the table are shifted up or moved up in sequence (i.e. in the FIFO sequence). After the rearrangement of table entries at 2612, at 2610, the new DIMD information is added as the last entry in the table.

According to the example inclusion order, DIMD merge candidates derived from DIMD information in the history-based table are added to the list of DIMD merge candidates after considering DIMD merge candidates derived from spatial adjacent blocks and spatial non-adjacent blocks of the current block.

At 2312, a set of combined DIMD merge candidates are added to the list of DIMD merge candidates, in accordance with some embodiments of the present disclosure.

Once the potential DIMD merge candidates, or more particularly their respective DIMD information, of all spatial adjacent, spatial non-adjacent, and history-based spatial neighbors have been considered for inclusion in the list of DIMD merge candidates, combined DIMD information may be added to the list of DIMD merge candidates. This process includes combining DIMD information from the DIMD information of DIMD merge candidates that are already in the list of DIMD merge candidates. DIMD merge candidates that are already in the list, but which are based on a combination of other DIMD merge candidates in the list, are not used to derive further combined DIMD merge candidates.

In some instances, HoGs from at least two DIMD merge candidates in the list of DIMD merge candidates are combined to create a new combined HoG, from which the blending modes and weights are derived to obtain the DIMD information of a new DIMD merge candidate. For example, the HoGs of at least two merge candidates are averaged, and the blending modes and weights are derived from this averaged HoG in a manner similar to that in the blending mode derivation in DIMD, as described, for example, in relation to FIG. 20. Considering the new combined DIMD merge candidate, location dependency is set for example to diagonal (0) as a default value, or can be set accordingly to the blending modes, i.e., that a vertical location dependency is set for a vertical blended mode, or a horizontal location dependency is set for a horizontal blended mode.

Combined DIMD merge candidates may be derived as follows: a candidate derived from the first and second DIMD merge candidates in the list of DIMD merge candidates; a candidate derived from the first and third DIMD merge candidates in the list of DIMD merge candidates; a candidate derived from the second and third DIMD merge candidates of the list of DIMD merge candidates; a candidate derived from the two first DIMD merge candidates of the list of DIMD merge candidates with a vertical location dependency; a candidate derived from the two first DIMD merge candidates of the list of DIMD merge candidates with a horizontal location dependency; or a candidate derived from combining DIMD information of all spatial adjacent blocks of the current block.

Alternatively or additionally, in some embodiments, the output DIMD information of the DIMD HoG merge mode is added as a combined candidate to the list of DIMD merge candidates.

Note that a merge candidate is not added to the list if it cannot be derived. For example, if there are only two candidates in the list of DIMD merge candidates before adding combined candidates, the second combined candidate, derived from the first and third candidates is skipped as there is no third candidate.

At 2314, a set of default DIMD merge candidates are added to the list of DIMD merge candidates, in accordance with some embodiments of the present disclosure.

One or more default DIMD information entries are added as DIMD merge candidates to the list of DIMD merge candidates. For example, DIMD parameters of two example default DIMD information entries are shown in Table 1.

TABLE 1
Example default DIMD parameters

| Default | Blending Modes | 0 (Planar) | 34 (Diag) | 18 (hor) |
|---|---|---|---|---|
| Mode 0 | Blending Weights | 16 | 24 | 24 |
| | Location Dependency | 0 | 0 | 2 |
| Default | Blending Modes | 0 (Planar) | 34 (Diag) | 50 (ver) |
| Mode 1 | Blending Weights | 16 | 24 | 24 |
| | Location Dependency | 0 | 0 | 1 |

The table shows default mode 0 and default mode 1, that each specify a set of predetermined DIMD parameters. One or more DIMD merge candidates having predetermined default DIMD information may be added to the list of DIMD merge candidates based on the DIMD parameters specified in Table 1.

The addition, if any, of combined merge candidates optionally followed by the default merge candidates completes the addition of merge candidates to the list of DIMD merge candidates.

Operation 2302, which includes 2306-2314 and which generates the list of DIMD merge candidates, may be identical at both the encoder and decoder. After 2302 is completed (i.e., the list of DIMD merge candidates is constructed), at 2304, blended modes, weights and location dependency are derived. At the encoder, this may include determining the best DIMD merge candidate in the list of DIMD merge candidates based on a cost (e.g., SAD, SATD, etc.) difference between a predicted block obtained using the DIMD predictor and the current block and/or based on rate distortion optimization of each of the DIMD merge candidates starting from the top (e.g., the lowest SAD, SATD cost) of the list of DIMD merge candidates. The index to the position of the best (selected) DIMD merge candidate in the list of DIMD merge candidates is determined. Subsequently, in some embodiments, the selected predictor may be added to the MPM list. If the current block is predicted by the DIMD predictor and encoded for transmission based on the DIMD prediction, then a DIMD enabled flag and the index can be transmitted on the bitstream.

At the decoder, 2304 may include parsing the bitstream for one or both of a DIMD enabled flag or index to the list of DIMD merge candidates. The index can be used to obtain the selected DIMD merge candidate from which to derive the DIMD predictor.

The DIMD merge mode has the benefit of the use of available neighbor information (e.g., in particular the DIMD information derived for the spatial neighbor blocks) to better suit the signal characteristics of the current block to be predicted. By re-using neighbor DIMD parameters, consistency between intra blocks is introduced. Moreover, the DIMD merge mode provides low complexity and competitive intra mode derivation. Once the intra mode is identified, only a syntax element (e.g., an index into the list of DIMD merge candidates) can be signaled. DIMD candidates' parameters can be ordered by relevance (e.g., using SAD, SATD, logic), reducing the mode signaling cost. The re-use of a substantial portion of the DIMD process, for example, low level operations and compute-intensive operations such as block pixels reconstruction etc. are unchanged, thereby saving hardware logic and potentially easing adoption by implementers.

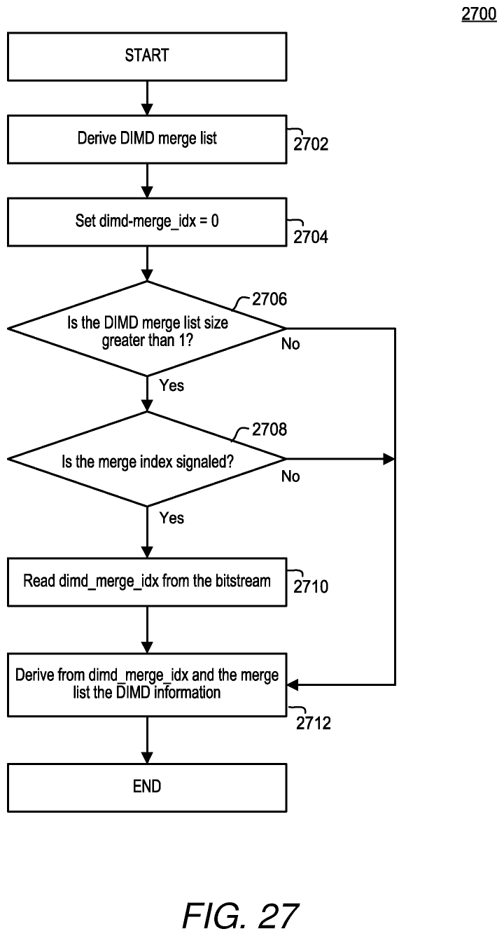

FIG. 27 is a flowchart 2700 of a method for determining the index into the list of DIMD merge candidates, in accordance with some embodiments of the present disclosure. The method may be performed at a decoder (e.g., decoder 300 in FIG. 3).

Considering the DIMD merge mode, an index referring to an entry in the list of DIMD merge candidates (which is both identically derived at the encoder and decoder sides) is signaled or derived. To proceed to the signaling of the DIMD merge index, one or more indicators may be signaled from the encoder to the decoder. A DIMD merge enabled flag is a syntax element to signal if a DIMD merge index is signaled, and a DIMD merge index is a syntax element to signal the DIMD merge index.

The DIMD merge index, referring to the candidate in the DIMD merge candidates list to use to reconstruct the block pixels (also referred to as the selected candidate), may be derived at the decoder for the following two cases. When the DIMD merge candidates list size is one, i.e., there is only one candidate in the list, it is then possible to bypass the index signaling as the index can be derived to DIMD merge index=0. Moreover, when the DIMD merge enabled flag is signaled, but is equal to zero, it can be derived that there is no DIMD merge index to extract from the bitstream and that DIMD merge index is set to the default value, zero.

For all other cases, the DIMD merge enabled flag equals 1 and a DIMD merge candidates list size larger than one, the DIMD merge index is decoded from the bitstream. Optionally, the DIMD merge enabled flag syntax element may be discarded. In this case, when the DIMD merge candidates list size is greater than one, i.e., the DIMD merge index is not derived, the DIMD merge index is read from the bitstream.

After the list of DIMD merge candidates is derived, and optionally reordered, at 2702, the DIMD merge index is initialized to 0 at 2704. At 2706, it is determined whether the list of DIMD merge candidates has more than one entry. If yes, then at 2708, it is determined whether the merge index is signaled. If the response is yes at 2708, then at 2710, the DIMD merge index is read from the bitstream. At 2712, the selected DIMD merge candidate is derived by accessing the merge candidates list using the DIMD merge index.

If at 2706, it is determined that the merge candidates list size is 1, then the method proceeds to 2712 to derive the selected DIMD merge candidate based on the DIMD merge index of 0. If at 2708, it is determined that the DIMD merge index is not signaled, then then the method proceeds to 2712 to derive the selected DIMD merge candidate based on the DIMD merge index of 0.

According to some embodiments, the DIMD merge mode operations at a decoder, such as, for example, decoder 300 in FIG. 3, may begin when an encoded video bitstream comprising encoded video data and associated DIMD information is received. A DIMD enabled flag and, optionally, a DIMD index, may be parsed from the bitstream. For each encoded video frame, each CTU in the frame is decoded. For each CU in the CTU, if DIMD merge mode is enabled, a list of DIMD merge candidates is constructed. The construction of the list of DIMD merge candidates may include adding DIMD information from spatial adjacent blocks, spatial non-adjacent blocks, from a history-based table, from combinations of DIMD merge candidates, and/or default DIMD information. In some embodiments, a reordering of the merge candidate list may be optionally performed. The DIMD parameters are derived from the DIMD merge candidates list using the index signaled (if signaled) in a bitstream. Thereafter, the DIMD predictor is generated according to determined blending weights, modes, and predictors location-dependency states.

According to some example embodiments, DIMD merge mode operations at an encoder, such as, for example, encoder 200 in FIG. 2, may be performed for each encoded video frame. For each CU in each CTU in the frame, if DIMD is enabled, a list of DIMD merge candidates is constructed. The construction of the list of DIMD merge candidates may include adding DIMD information from spatial adjacent blocks, spatial non-adjacent blocks, from a history-based table, from combinations of DIMD merge candidates, and/or default DIMD information. In some embodiments, a reordering of the list of DIMD merge candidates may be optionally performed. Subsequently, the best DIMD merge candidate is selected. The selection may include generating a DIMD predictor for each (or some) DIMD merge candidate from the list of DIMD merge candidates according to determined blending weights, modes, and predictors location-dependency states. Based on each predictor, a cost difference (e.g., SATD, SAD, etc.) between the prediction and reconstruction samples of the template is calculated, and, based on the minimum cost, the best DIMD merge candidate is selected and the corresponding index in the list of DIMD merge candidates is determined. In some embodiments, the best DIMD merge candidate is added to a list of candidate intra modes (e.g., the MPM list) that are to be considered for the CU. Subsequently, if the best DIMD information is selected from the candidate list for encoding the CU, then the index may be transmitted in a bitstream with an indication that DIMD merge mode is enabled (e.g., that the current block is encoded in the DIMD merge mode).

In some embodiments, to improve the relevance of the list of DIMD merge candidates, a potential DIMD merge candidate is added to the list only if its DIMD information differs from all DIMD information already in the list. For example, if a candidate has been derived from the left block (L), and the left block and the bottom left block (BL) have the same DIMD parameters, e.g., the blending modes, the blending weights, and the location dependency, the BL block's DIMD information is not added as a new DIMD merge candidate in the list of DIMD merge candidates. As another example, if a preconfigured default DIMD information has the same DIMD parameters as a candidate in the list of DIMD merge candidates, the preconfigured default DIMD information is not added to the list.

In some embodiments, the list of DIMD merge candidates is limited to a preconfigured maximum list size. Additionally, or alternatively, respective sets of DIMD merge candidates (e.g., each family such as candidates from spatial adjacent blocks, spatial non-adjacent blocks, a history-based table, combination of candidates, and default DIMD information) may be configured with a maximum number of candidate entries.

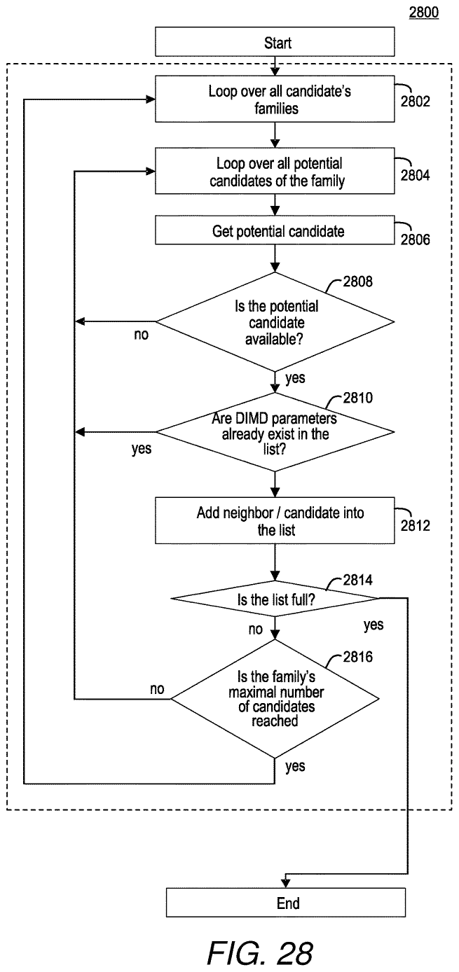

FIG. 28 illustrates a flowchart 2800 of a method for generating a DIMD merge candidates list that does not exceed a preconfigured maximum number of DIMD merge candidates in the entire list and does not exceed a preconfigured maximum number of DIMD merge candidates in each family of merge candidates, according to some embodiments of the present disclosure. The generation of a list of DIMD merge candidates in accordance with the method of flowchart 2800 may be performed reciprocally by an encoder (e.g., encoder 200 in FIG. 2) or by a decoder (e.g., decoder 300 in FIG. 3).

The method of flowchart 2800 begins at 2802. At 2802 the coder (e.g., encoder or decoder) is configured to repeat subsequent operations 2804-2816 for each family of DIMD merge candidates (sometimes also referred to herein as sets of merge candidates). For example, as described above in relation to FIG. 23, the list of DIMD merge candidates may be constructed by adding merge candidates from several candidate families such as spatial adjacent neighbor blocks, spatial non-adjacent neighbor blocks, spatial history-based table blocks, combined entries, and default entries. Thus, in some embodiments, 2804-2816 are repeated for each family of DIMD merge candidates.

At 2804, the coder is configured to repeat 2806-2816 for all DIMD merge candidate entries of a selected family of merge candidate entries. For example, for each selected family of the merge candidate families such as, for example, DIMD information of spatial adjacent neighbor blocks, spatial non-adjacent neighbor blocks, spatial history-based table blocks, combined entries, and default entries, 2806-2816 may be repeated until adding of candidate entries from the selected candidate family is completed.

At 2806, a potential candidate from the selected family is identified. For example, when the selected family is the spatial adjacent blocks, each of the blocks identified as L, A, AR. AL, and BL shown in FIG. 24 may be considered in a predetermined sequence. Similarly, when the selected family is the spatial non-adjacent blocks, each of the blocks in the pattern and sequence as shown in FIG. 25 can be considered for the potential candidate, or when the selected family is the history-based table, each entry in the history-based table can be considered as a potential candidate in a FIFO, or when the selected family is the family of combined entries, a set of predetermined combinations of entries already in the list of DIMD merge candidates as described above can be considered in sequence for a potential candidate, or when the selected family is the family of default candidates, each predetermined default candidate can be considered as a potential candidate.

At 2808, it is determined whether the potential candidate is available. For example, in the spatial adjacent and the spatial non-adjacent neighbor blocks, it may be determined whether the identified block has been reconstructed. In some instances, even if reconstructed, a block may not be considered available if it was not predicted or reconstructed with DIMD or DIMD associated prediction mode, or if the DIMD information was not previously derived. For combined candidates, it may be determined whether each of the plurality of candidates that are to be combined together according to a preconfigured combination pattern (e.g., combination of entries 1 and 3 of the list, etc.) are available. For example, when the predetermined pattern is to combine the first two entries in the list of DIMD merge candidates, it can be determined whether each of the first two entries are available in the list of DIMD merge candidates. If the currently selected candidate entry is not available, then the method loops back to 2804 to select the next candidate from the currently selected family, otherwise the method proceeds to 2810.

At 2810, it is determined whether the DIMD parameters of the potential DIMD merge candidate are already in the list of DIMD merge candidates. For example, it is determined whether there already is a DIMD merge candidate entry in the list such that its DIMD information, or more specifically the set of DIMD parameters that define DIMD information, is identical to the DIMD information of the potential DIMD merge candidate. If an entry with the identical DIMD information is not available, then the method loops back to 2804 to select the next candidate from the currently selected family, otherwise the method proceeds to 2812.

At 2812, the DIMD information of the neighbor/candidate is added to the list of DIMD merge candidates. The adding may include adding the new candidate at the end of the current list of DIMD merge candidates.

At 2814, it is determined whether the merge candidate list is full. This determination is based on comparing the total number of DIMD merge candidates currently in the list to a preconfigured maximum number of entries for the list. If the list is full, then the list generation is complete. Otherwise, the method proceeds to 2816.

At 2816, it is determined whether the number of DIMD merge candidates added to the list from the currently selected family of potential DIMD merge candidates has reached a predetermined maximum number of entries for the currently selected family. In some embodiments, a separate maximum number of candidates may be defined for each of the families. In some other embodiments, a same maximum number of entries may be defined for all candidate families. If the number of DIMD merge candidates for the currently selected family has not exceeded the predefined maximum number for that family, the method loops back to 2804 to select the next potential candidate from the selected family. Otherwise, if the number of entries for the family has exceeded the predefined maximum number for that family, then the method proceeds to 2802 to select the next family of potential candidates.

The method of flowchart 2800, provides for generating the list of DIMD merge candidates (e.g., on both the encoder and decoder) in a manner that bounds the number of DIMD merge candidates in the list, and thus limits the amount of increased complexity. By reducing the size of the list, a smaller number of DIMD merge candidates are derived and evaluated, reducing the intra mode complexity at the decoder and the encoder. The list is bounded, e.g., the list has a maximum of six candidates. In this case, a candidate is added to the list only if the number of candidates included in the list is lower than a preconfigured maximum DIMD merge candidates list size.

Once the list is full, all remaining steps in the list derivation process can be skipped. For example, if the DIMD merge candidates list maximum size is 6, and already contains 6 candidates, e.g., all spatial adjacent candidates (L, A, AL, AR, BL), and one spatial non-adjacent candidate, the list derivation process may be stopped and other families of candidates that were to be considered according to the inclusion order, e.g., non-adjacent candidates, history-based DIMD candidates, combined candidates, and default DIMD candidates are neither computed nor considered.

Furthermore, for each candidate's family, a limit on the maximal number of added candidates may be set. For example, according to an embodiment: all spatial adjacent candidates are considered (e.g., the maximum number of spatial adjacent candidates in the list is five); the maximum number of non-adjacent candidates can be bounded to 4 candidates; the maximum number of history-based candidates is 2; the maximal number of candidates combined candidates is 4; and the maximum number of default candidates is 2. If the DIMD merge candidates list maximum size is 8, and already contains 2 candidates, e.g., one spatial candidate (for example AR), one non-adjacent candidate, and no history-based candidates, maximum of 4 combined candidates will be added to the list as the maximum number of this family of candidates is 4.

By bounding the list of DIMD merge candidates and discarding duplicate candidates, the list of DIMD merge candidates contains more diverse and more relevant DIMD information, increasing the DIMD reliability, and the DIMD competitiveness.

One or more of the features of rejection of duplicates, limiting of the maximum size of the list of DIMD merge candidates, and/or limiting of the maximum number of number of merge candidates from each family of DIMD merge candidates can be implemented in the generating of the list of DIMD merge candidates such as, for example, shown in FIG. 23. For example, as each merge candidate is considered for insertion into the list of DIMD merge candidates one or more of the checks for duplicates (e.g., as described in relation to 2810), whether the maximum list size is reached (e.g., as described in relation to 2814), and/or whether the maximum number of merge candidates of a particular family of merge candidates is reached, can be performed.

In some embodiments, in order to improve the DIMD merge candidates list relevance, a reordering on the list may be processed to sort the candidate based on a template matching cost. In some embodiments, if template matching is enabled (e.g., by configuration or an indication (e.g., a flag or syntax element) signaled by the encoder to the decoder indicating template matching ordering is selected or enabled), a template matching cost-based reordering is applied after merge candidates are added to the list (e.g., all merged candidates added). The reordered list may then be used to derive the blended DIMD modes etc. By reordering the list, the likelihood of the selected merge candidate having a smaller index number is likely to increase, and the smaller index values can be more efficiently encoded. In some other embodiments, the template matching cost-based reordering can, instead of being performed on the entire DIMD merge candidate list, can be performed only on a predetermined number of candidates at the top of the list or on a set of predetermined families of candidate entries of the list. When the template matching cost reordering is applied to a set of families of candidate entries of the list, for example, after the adding DIMD information to the list from the spatial adjacent blocks, spatial non-adjacent blocks, and the history-based table, the DIMD information added can be reordered based on the template matching cost before combined candidates are added to the list. In an example, the set of predetermined families may include only the spatial adjacent blocks, only the spatial non-adjacent blocks, or only the spatial adjacent and non-adjacent blocks. In another example, the set of predetermined families may include only the spatial adjacent and non-adjacent blocks and history-based table of blocks.

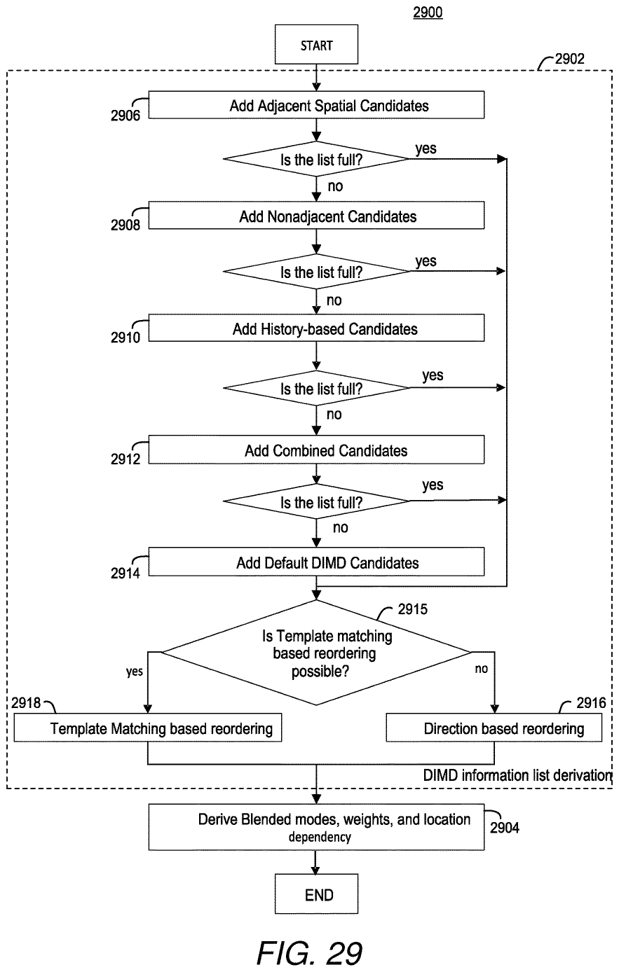

FIG. 29 shows a flowchart 2900 of a method of DIMD merge candidates list derivation using reordering, in accordance with some embodiments of the present disclosure. Operations of flowchart 2900 may be performed reciprocally by an encoder (e.g., encoder 200 in FIG. 2) or by a decoder (e.g., decoder 300 in FIG. 3).

Similar to the method of flowchart 2300 described above, the method of flowchart 2900 comprises a DIMD merge candidates list derivation operation 2902 followed by an operation 2904 deriving blended modes, weights and location dependency. Operations 2906-2914 in the derivation of the DIMD merge candidates list operation 2902 are identical to the operation 2306-2314 in the derivation of the DIMD merge candidates list operation 2302. In the method of flowchart 2900 however, the derivation of the list of DIMD merge candidates includes a reordering that follows the completion of the construction of the initial list of DIMD merge candidates after 2914.

For example, at 2915, it is determined whether template matching based reordering can be performed. If yes, at 2918, template matching based reordering of the DIMD merge candidates list is performed.

During the template matching cost-based reordering process, the template matching cost of a DIMD merge candidate is measured by a cost measure (e.g., SAD, SSD, SATD) between a template of samples derived from the DIMD merge candidate and the corresponding reconstructed samples. The list is then sorted, from the DIMD merge candidate with the lowest template matching cost to the highest template matching cost. The lower the template matching cost, the more relevant the candidates at the beginning of the list are.

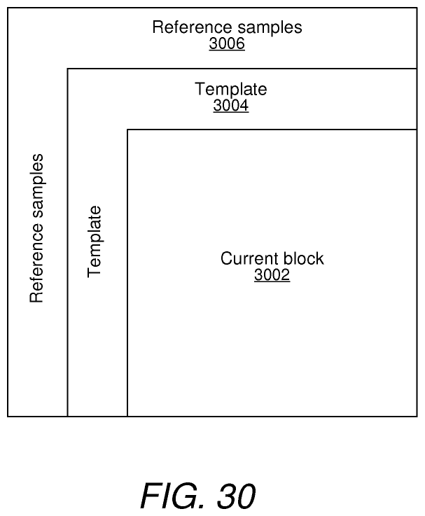

For example, like in FIG. 30, the template used for the reordering may be an L-shaped area (that includes left and top pixels neighboring the block) 3004, with size depending on the current block 3002 size. The template area shows the neighboring reconstructed pixels that are used to measure the template matching cost. The current block template 3004 forms a set of samples derived from DIMD merge candidate using reference samples 3006. For example, considering a 32×16 block, the template size is formed of the top part compounded of 32×2 samples, and the left part compounded of 2×16 samples.

Optionally, to reduce the complexity of the DIMD merge template-based reordering, several families of candidates are excluded from the reordering, i.e., their positions in the DIMD merge candidates list are unchanged by the reordering. For example, in some embodiments, the candidate families that are likely to yield less relevant candidates may be excluded from the reordering because their probability to be selected is low. For instance, history-based DIMD merge candidates, combined DIMD merge candidates, and default DIMD merge candidates can be excluded from the reordering.

An example of a template matching reordering process applied to an initial list of DIMD merge candidates is shown in Table 3. The initial list, before the reordering is shown in Table 2. In this example, the template matching reordering is applied to a limited number of DIMD merge candidates, the first three. All other three candidates' order is unchanged.

TABLE 2
Example of DIMD merge candidates list after
the Template Matching cost reordering

| | Blending | Blending | Location | Template |
|---|---|---|---|---|
| | Modes | Weights | Dependency | Match Cost |
| 0 | {0, 34, 24} | {16, 30, 18} | {0, 2, 2} | 495 |
| 1 | {0, 50, 14} | {16, 28, 20} | {0, 1, 2} | 368 |
| 2 | {0, 3, 24} | {16, 24, 24} | {0, 2, 2} | 240 |
| 3 | {0, 34, 24} | {16, 36, 12} | {0, 1, 2} | 687 |
| 4 | {0, 12, 14} | {16, 24, 24} | {0, 2, 2} | 120 |
| 5 | {0, 44, 42} | {16, 26, 22} | {0, 1, 1} | 347 |

TABLE 3
Example of DIMD merge candidates list after
the Template Matching cost reordering

| | Blending | Blending | Location | Template |
|---|---|---|---|---|
| | Modes | Weights | Dependency | Match Cost |
| 0 | {0, 3, 24} | {16, 24, 24} | {0, 2, 2} | 240 |
| 1 | {0, 50, 14} | {16, 28, 20} | {0, 1, 2} | 368 |
| 2 | {0, 34, 24} | {16, 30, 18} | {0, 2, 2} | 495 |
| 3 | {0, 34, 24} | {16, 36, 12} | {0, 1, 2} | 687 |
| 4 | {0, 12, 14} | {16, 24, 24} | {0, 2, 2} | 120 |
| 5 | {0, 44, 42} | {16, 26, 22} | {0, 1, 1} | 347 |

Furthermore, the template-based reordering of the DIMD merge candidates list can be enabled for CUs with size less than or equal to 64 in width and height. This largest CU size for intra template matching may be configurable and signaled. Optionally, the template matching reordering can be disabled and signaled.

The reordering provides a way to consider many candidates, but to evaluate only some of the considered candidates in order to reduce the complexity overhead. For example, a 20 DIMD merge candidates list can be built, while only some of them (e.g., 6) will be shortlisted, that will be evaluated using RDO (RD-check).

The shape and size of the template used in the reordering can be aligned with the template size and shape used in other functions of the encoder or decoder, like in the TIMD (Template Intra Mode Derivation) to save hardware logic e.g., easing its adoption by implementers.

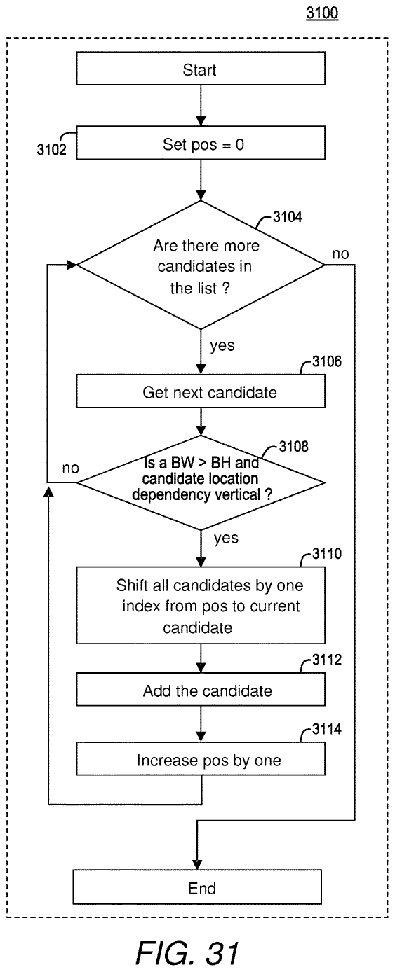

If at 2915, it is determined that template matching cost-based reordering is not possible, then another reordering, for example, direction based reordering is performed at 2916. An example direction-based reordering is described below in relation to FIG. 31.

After the template matching cost-based reordering at 2918 or the direction based reordering at 2916, the method of flowchart 2900 proceeds to 2904. At 2904, the blended modes, weights and location dependency of a selected intra prediction mode is determined from the DIMD merge candidates list in an identical manner as described in relation to 2304 in the method of flowchart 2300.

FIG. 31 illustrates a flowchart 3100 of a method of reordering the list of DIMD merge candidates in accordance with direction. For example, at 2916 described above, the list of DIMD merge candidates is reordered, in accordance with some embodiments of the present disclosure. For example, the reordering may be performed in accordance with a direction-based reordering. Optionally, to improve the DIMD merge candidate list relevance, a reordering on the list may be processed. According to some embodiments, the reordering is processed to sort the candidates based on location dependency. Operations of flowchart 3100 may be performed reciprocally by an encoder (e.g., encoder 200 in FIG. 2) or by a decoder (e.g., decoder 300 in FIG. 3).

Some implementations support various CU sizes and shapes, especially rectangular shapes. Considering a vertical CU (4×16 for instance), horizontal predictions can provide further compression efficiency than vertical predictions. Then, the list of DIMD merge candidates is reordered to privilege DIMD merge candidates with horizontal location dependency over DIMD merge candidates with vertical location dependency. Respectively, regarding horizontal CU (32×8 for instance), DIMD merge candidates with vertical location dependency will be privileged compared to DIMD merge candidates with horizontal location dependency.

Flowchart 3100 of an example method for vertical location dependency privileged DIMD merge candidate list reordering, applied when the CU is rectangular, with its width (BW) higher than its height (BH), according to some embodiments.

After initializing a counter at 3102, the method of flowchart 3100 proceeds to repeat 3104-3114 for each DIMD merge candidate in the list of DIMD merge candidates. At 3104, it is determined whether there are any more merge candidates to be processed in the list, and if there are no more merge candidates, the reordering is considered completed. If there are more merge candidates to be processed, then 3106-3114 are performed. At 3108, the next merge candidate is obtained, and at 3110 it is checked whether its width is greater than height. If the merge candidate's width is not greater than the height, then that merge candidate is not processed any further, and the method of flowchart 3100 returns to 3104 to pick the next merge candidate if any. If the merge candidate's width is greater than its height, then all merge candidates are shifted by one index from the counter position to the current merge candidate. Then the current candidate is added at 3112, and at 3114, the counter is incremented by 1.

An example of direction-based reordering process applied to an initial DIMD merge candidate list (shown in Table 4) is reported in Table 5. In this example, the CU is vertically oriented, i.e., its width is lower than its height, so the DIMD merge candidates with horizontal location dependency (e.g., location dependency equals 2) are privileged and set at the beginning of the list of DIMD merge candidates.

TABLE 4
Example of DIMD merge candidates list
before the direction-based reordering

| | Blending | Blending | Location |
|---|---|---|---|
| | Modes | Weights | Dependency |
| 0 | {0, 34, 24} | {16, 30, 18} | {0, 2, 2} |
| 1 | {0, 50, 14} | {16, 28, 20} | {0, 1, 2} |
| 2 | {0, 3, 24} | {16, 24, 24} | {0, 2, 2} |
| 3 | {0, 34, 24} | {16, 36, 12} | {0, 1, 2} |
| 4 | {0, 12, 14} | {16, 24, 24} | {0, 2, 2} |
| 5 | {0, 44, 42} | {16, 26, 22} | {0, 1, 1} |

TABLE 5
Example of DIMD merge candidates list
after the direction-based reordering

| | Blending | Blending | Location |
|---|---|---|---|
| | Modes | Weights | Dependency |
| 0 | {0, 34, 24} | {16, 30, 18} | {0, 2, 2} |
| 1 | {0, 3, 24} | {16, 24, 24} | {0, 2, 2} |
| 2 | {0, 12, 14} | {16, 24, 24} | {0, 2, 2} |
| 3 | {0, 50, 14} | {16, 28, 20} | {0, 1, 2} |
| 4 | {0, 34, 24} | {16, 36, 12} | {0, 1, 2} |
| 5 | {0, 44, 42} | {16, 26, 22} | {0, 1, 1} |

Optionally, the direction-based reordering can be disabled by default, and the activation can be signaled as needed. The direction-based reordering may be enabled when the template-based reordering is disabled.

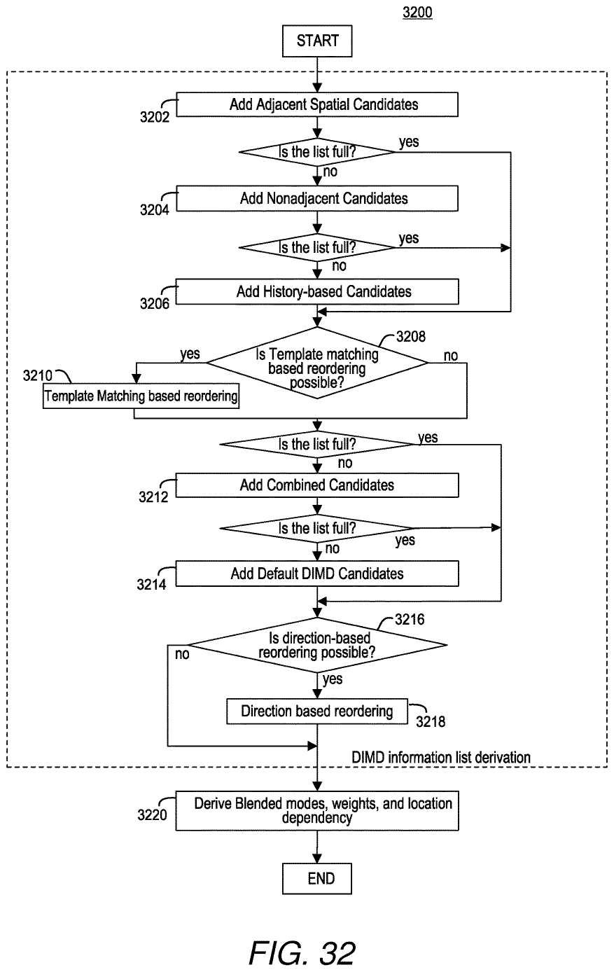

FIG. 32 illustrates a flowchart 3200 of a method by which the list of DIMD merge candidates, or part of the list of DIMD merge candidates, can be reordered in accordance with a template matching cost-based reordering, in accordance with some embodiments of the present disclosure. Operations of flowchart 3200 may be performed reciprocally by an encoder (e.g., encoder 200 in FIG. 2) or by a decoder (e.g., decoder 300 in FIG. 3).

The method of flowchart 3200 may begin at 3202. At 3202, none, one or more DIMD merge candidates are added from the set of spatial adjacent neighbor blocks of the current block. The addition of DIMD merge candidate from a set of spatial adjacent neighbor blocks is described above in relation to FIG. 23 at 2306.

Then after optionally checking whether the list is full, the method proceeds to 3204. At 3204, none, one or more DIMD merge candidates are added from the set of spatial non-adjacent neighbor blocks of the current block. The addition of DIMD merge candidate from a set of spatial non-adjacent neighbor blocks is described above in relation to FIG. 23 at 2308.

Then after optionally checking whether the list is full, the method proceeds to 3206. At 3206, none, one or more DIMD merge candidates are added from the set of history-based candidates. The addition of DIMD merge candidate from a set of history-table based candidate is described above in relation to FIG. 23 at 2310.

At 3208, it is determined whether template matching cost-based reordering is possible/enabled. If yes, at 3210, the DIMD merge candidate list is reordered according to a template matching cost-based reordering. The template matching cost of a DIMD merge candidate during the reordering process is measured by the template cost difference between samples of a template of the current block and their corresponding reference samples. The template comprises a set of reconstructed samples neighboring to the current block. Reference samples of the template are located based on the DIMD information of the DIMD merge candidate.

After the reordering at 3210 or upon it being determined at 3208 that no reordering is to be performed, the method proceeds to adding more DIMD merge candidates to the merge candidate list.

Then after optionally checking whether the list is full, the method proceeds to 3212. At 3212, none, one or more DIMD merge candidates are added from the DIMD merge candidates in the merge candidate list. The addition of DIMD merge candidates from a set of DIMD merge candidates is described above in relation to FIG. 23 at 2312.

Then after optionally checking whether the list is full, the method proceeds to 3214. At 3214, none, one or more DIMD merge candidates are added from the default DIMD information. The addition of DIMD merge candidates from a set of default DIMD information is described above in relation to FIG. 23 at 2314.

At 3216, it is determined whether direction-based reordering is possible/enabled. If yes, at 3216, the list of DIMD merge candidates is reordered according to a direction-based reordering at 3218. Direction-based reordering is described above in relation to FIG. 23 at 2316.

After the reordering at 3218 or upon it being determined at 3216 that no reordering is to be performed (e.g., direction-based reordering may be disabled when template matching based reordering is performed), the method proceeds to derive blended modes etc. at 3220.

At 3220, blended modes, weights and location dependency are derived. According to some embodiments, the derivation of the blended modes, weights and location dependence can be performed as described at 2304 in relation to FIG. 23.

According to flowchart 3200, in some embodiments, after DIMD merge candidates are added from the spatial adjacent blocks, spatial non-adjacent blocks, and the history-based table, template matching reordering may be performed on those candidates, and then optionally subsequently when all candidates have been added to the list, the entire list can be reordered using either template matching cost-based reordering or direction-based reordering.

It should be noted that in the method of flowchart 3200, for each DIMD merge candidate, one or more of the checking for duplicates, checking for exceeding a limit on the number of merge candidates in the list, and checking for exceeding a limit on the number of merge candidates defined for a family of merge candidates.

The reordering of the list of DIMD merge candidates improves the likelihood of the selected DIMD merge candidate having a smaller valued index, which is more efficient to encode.

TIMD, described above, identifies up to 2 intra prediction modes and corresponding weights which are fused to derive the TIMD predictors. The TIMD process differs from the DIMD process, but both processes may output several blending modes and their corresponding weights. In some embodiments, TIMD information (e.g., TIMD blending modes and weights) is reused to derive DIMD information. For example, in some embodiments, several candidates derived from neighboring TIMD information are added to the DIMD merge candidates list.

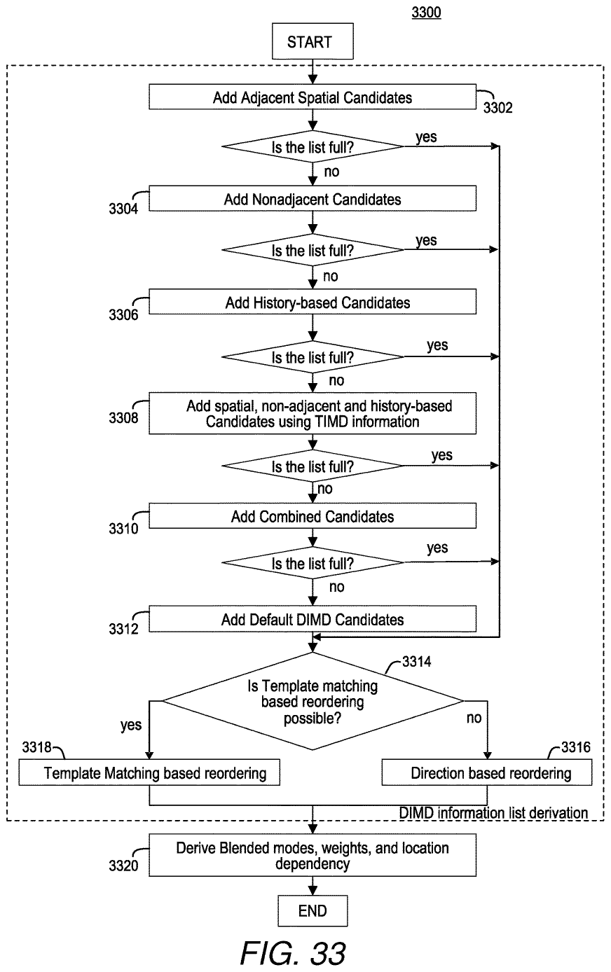

The TIMD process requires the derivation of the MPM list, and therefore, a block using the TIMD intra mode also derives its DIMD information. Consequently, a neighbor block using a TIMD mode has its DIMD information available, and that can be used to derive one or more merge candidates for the list of DIMD merge candidates. However, as the TIMD information is an alternate representation of the block, the neighbor TIMD information can also be used to derive another DIMD merge candidate. In some embodiments of this disclosure, as the TIMD information has less intra modes to blend, it may be considered that DIMD merge candidates derived from TIMD information are less accurate and therefore are added to the list of DIMD merge candidates after the history-based candidates are added as shown in FIG. 33.

FIG. 33 illustrates a flowchart 3300 of a method by which the list of DIMD merge candidates can be generated by considering, in addition to a first set of families of spatial adjacent neighbor blocks, spatial non-adjacent neighbor blocks, and history-based merge candidates, also a second set of families of spatial adjacent neighbor blocks, spatial non-adjacent neighbor blocks, and history-based merge candidates, for addition to the list of DIMD merge candidates. Operations of flowchart 3300 may be performed reciprocally by an encoder (e.g., encoder 200 in FIG. 2) or by a decoder (e.g., decoder 300 in FIG. 3).

The method of flowchart 3300 may begin at 3302. At 3302, none, one or more DIMD merge candidates are added from the family of spatial adjacent neighbor blocks of the current block. The addition of DIMD merge candidates from a set of spatial adjacent neighbor blocks is described above in relation to FIG. 23 at 2306.

Then after optionally checking whether the list is full, the method proceeds to 3304. At 3304, none, one or more DIMD merge candidates are added from the family of spatial non-adjacent neighbor blocks of the current block. The addition of DIMD merge candidates from a set of spatial non-adjacent neighbor blocks is described above in relation to FIG. 23 at 2308.

Then after optionally checking whether the list is full, the method proceeds to 3306. At 3306, none, one or more DIMD merge candidates are added from the family of history-based merge candidates. The addition of DIMD merge candidates from a family of history-table based candidates is described above in relation to FIG. 23 at 2310.

Then after optionally checking whether the list of DIMD merge candidates is full, the method proceeds to 3308. At 3308, none, one or more merge candidates are added to the list of DIMD merge candidates from a second set of merge candidates from each of a family of spatial adjacent neighbor blocks, spatial non-adjacent neighbor blocks, and history-based merge candidates. In an example embodiment, the second set of merge candidates is selected based on TIMD information of the respective merge candidates.

Table 6 shows an example of a list of TIMD information from neighbors that are reused to derive DIMD merge candidates. The result of the derivation is reported in Table 7 with the following methodology (as an example): TIMD blending modes may be reused and completed with the planar mode (e.g., intra mode 0), TIMD weights may be rescaled to fit the DIMD process, and a location dependency may be set to a default value (0: diagonal). Further constraints can be added to derive a DIMD merge candidate from TIMD information, like, for example, the TIMD information must contain 2 blending modes, etc. Adding such constraints may change the derived DIMD merge candidates as reported in Table 8. From Table 6, the fourth candidate (index=3) is not used to derive a DIMD candidate as it contains only one mode.

TABLE 6
Example list of TIMD information from neighbors

| | Blending | Blending |
|---|---|---|
| | Modes | Weights |
| 0 | {34, 24} | {46, 18} |
| 1 | {50, 14} | {38, 26} |
| 2 | {3, 24} | {40, 24} |
| 3 | {34} | {64} |
| 4 | {12, 14} | {38, 26} |
| 5 | {44, 42} | {32, 32} |

TABLE 7
Example derived DIMD candidates
from neighbors' TIMD information.

| | Blending | Blending | Location |
|---|---|---|---|
| | Modes | Weights | Dependency |
| 0 | {0, 34, 24} | {16, 35, 13} | {0, 0, 0} |
| 1 | {0, 50, 14} | {16, 29, 19} | {0, 0, 0} |
| 2 | {0, 3, 24} | {16, 30, 18} | {0, 0, 0} |
| 3 | {0, 34} | {16, 48} | {0, 0, 0} |
| 4 | {0, 12, 14} | {16, 29, 19} | {0, 0, 0} |
| 5 | {0, 44, 42} | {16, 24, 24} | {0, 0, 0} |

TABLE 8
Example derived DIMD candidates
from neighbors' TIMD information

| | Blending | Blending | Location |
|---|---|---|---|
| | Modes | Weights | Dependency |
| 0 | {0, 34, 24} | {16, 35, 13} | {0, 0, 0} |
| 1 | {0, 50, 14} | {16, 29, 19} | {0, 0, 0} |
| 2 | {0, 3, 24} | {16, 30, 18} | {0, 0, 0} |
| 3 | {0, 12, 14} | {16, 29, 19} | {0, 0, 0} |
| 4 | {0, 44, 42} | {16, 24, 24} | {0, 0, 0} |

Embodiments of the present disclosure are not limited to deriving DIMD parameters for DIMD merge candidates using two TIMD blending modes. In some embodiments, other numbers of TIMD blending modes and weights may be used when deriving the DIMD parameters from TIMD information.

After 3308, the method proceeds to 3310. At 3310, none, one or more combined DIMD merge candidates are added based on DIMD merge candidates in the list of DIMD merge candidates. The addition of DIMD merge candidates from DIMD merge candidates already in the list of DIMD merge candidates is described above in relation to FIG. 23 at 2312.

Then after optionally checking whether the list is full, the method proceeds to 3312. At 3312, none, one or more DIMD merge candidates are added from the default DIMD information. The addition of DIMD merge candidates from a set of default DIMD information is described above in relation to FIG. 23 at 2314.

At 3314, it is determined whether to perform reordering, and if reordering is to be performed. In accordance with the determination at 3314, a reordering is performed at 3316 or 3318. Operations 3314-3318 may be identical to the operations 2915-2918 described in relation to the method of flowchart 2900.

The reordered DIMD merge candidate list (or in the case that it is decided to not reorder at 3314, the DIMD merge candidate list without being reordered) is used at 3320 to derive blended modes, weights, and location dependency. The derivation of the blended modes, weights, and location dependency can be performed identically or similarly to the manner described above at 2304 in relation to FIG. 23.

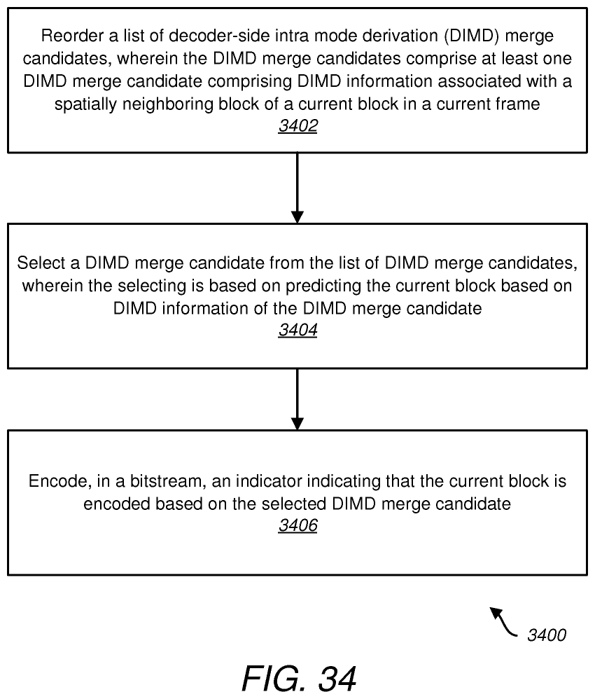

FIG. 34 illustrates a flowchart 3400 of a method for encoding a current block with DIMD merge mode in accordance with some embodiments of the present disclosure. The method of flowchart 3400 provides for generating a reordered list of DIMD merge candidates. The method of flowchart 3400 may be implemented by an encoder (e.g., encoder 200 in FIG. 2).

The method of flowchart 3400 may begin at 3402. At 3402, a reordering is performed on a list of decoder-side intra mode derivation (DIMD) merge candidates. The DIMD merge candidates comprise at least one DIMD merge candidate comprising DIMD information associated with a spatially neighboring block of a current block in a current frame.

The reordering may include reordering according to template matching costs of respective DIMD merge candidates in the list of DIMD merge candidates. The reordering may be of all DIMD merge candidates in the list of DIMD merge candidates, or only a first part of the list of DIMD merge candidates. When reordering only a first part of the list of DIMD merge candidates, it may be followed by reordering all DIMD merge candidates in the list of DIMD merge candidates according to a directionality of respective DIMD merge candidates. The first part that is reordered may include all DIMD merge candidates from any spatial neighbor block, and in one implementation, after the reordering of only the first part of the list of DIMD merge candidates, adding of DIMD merge candidates to the list of DIMD merge candidates by combining DIMD information of two or more DIMD merge candidates in the list of DIMD merge candidates may be performed. When reordering based on template matching costs, template matching costs may be determined based on a set of samples derived from a DIMD merge candidate using reference samples adjacent to a template of the current block.

The reordering may alternatively be according to a location dependency of respective DIMD merge candidates in the list of DIMD merge candidates. The reordering according to a location dependency of respective DIMD merge candidates may include privileging, in the rearranged order, one of horizontal location dependency or vertical location dependency based on a dimension of the current block.

The list of DIMD merge candidates may include a first set of merge candidates added based on DIMD information and a second set of DIMD merge candidates added based on Template-based Intra Mode Derivation (TIMD) information. The second set of DIMD merge candidates may include DIMD merge candidates derived from TIMD information derived from a spatial adjacent block of the current block, a non-adjacent block in the current frame, or another block in the current frame.

The DIMD merge candidates may include a second DIMD merge candidate comprising one or more DIMD blending modes associated with an adjacent neighbor block of the current block, a non-adjacent neighbor block in the current frame, another block in the current frame, a combination of DIMD merge candidates from the list of DIMD merge candidates; or a third DIMD merge candidate comprising predetermined DIMD information.

Each DIMD merge candidate, of the DIMD merge candidates, may include one or more DIMD intra modes and one or more corresponding blending weights. Each DIMD merge candidate may further include one or more location dependencies corresponding to the one or more DIMD intra modes, respectively.

The generating of the list of DIMD merge candidates may include adding respective DIMD merge candidates to the list of DIMD merge candidates in an inclusion order. The inclusion order may include DIMD merge candidates associated with adjacent neighbor blocks, if any, preceding DIMD merge candidates associated with non-adjacent neighbor blocks, if any, and the DIMD merge candidates associated with adjacent neighbor blocks and the DIMD merge candidates associated with non-adjacent neighbor blocks, if any, preceding DIMD merge candidates from a history-based buffer.

When adding respective DIMD merge candidates to the list of DIMD merge candidates in an inclusion order, adding the potential DIMD merge candidate to the list of DIMD merge candidates as a DIMD merge candidate if and only if, before the adding: DIMD information of the potential DIMD merge candidate is not already present in the list of DIMD merge candidates; a total number of DIMD merge candidates in the list of DIMD merge candidates is less than a predetermined maximum list limit; and/or a number of DIMD merge candidates currently in the list of DIMD merge candidates a corresponding one of the adjacent neighbor blocks, the non-adjacent neighbor blocks, or the history-based buffer is less than or equal to a predetermined maximum family limit. An example of the plurality of families of potential DIMD merge candidates being considered in an inclusion order is shown at 2306-2314 in the method of flowchart 2300.

At 3404, a DIMD merge candidate is selected from the list of DIMD merge candidates, based on predicting the current block based on DIMD information of the DIMD merge candidate. The selecting may include selecting based on a rate distortion optimization (RDO) metric of the DIMD merge candidate.

At 3406, an indicator indicating that the current block is encoded based on the selected DIMD merge candidate is encoded in the bitstream.

The indicator may include at least one of a DIMD merge enabled flag and an index to a position of the selected DIMD merge candidate in the list of DIMD merge candidates. The encoding may include, when a size of the list of DIMD merge candidates is less than a threshold size, encoding only a DIMD merge enabled flag as the indicator.

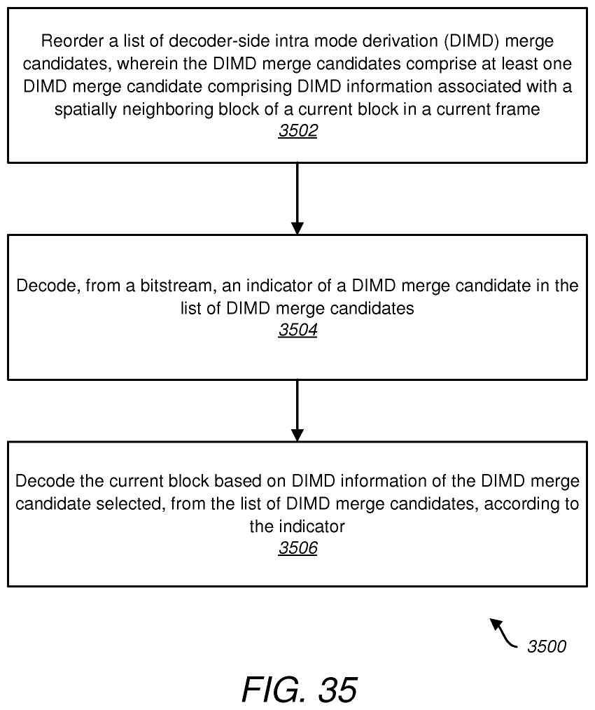

FIG. 35 illustrates a flowchart 3500 of a method for decoding a current block with DIMD merge mode in accordance with some embodiments of the present disclosure. The method of flowchart 3500 provides for generating a reordered list of DIMD merge candidates. The method of flowchart 3500 may be implemented by a decoder (e.g., decoder 300 in FIG. 3).

The method of flowchart 3500 may begin at 3502. At 3502, a reordering is performed on a list of decoder-side intra mode derivation (DIMD) merge candidates. The DIMD merge candidates comprise at least one DIMD merge candidate comprising DIMD information associated with a spatially neighboring block of a current block in a current frame. The reordering at 3502 may be identical to the reordering 3402 described above in relation to the method of flowchart 3400.

At 3504, an indicator of a DIMD merge candidate in the list of DIMD merge candidates is decoded from the bitstream.

At 3506. the current block is decoded based on DIMD information of the DIMD merge candidate selected from the list of DIMD merge candidates according to the indicator.

The indicator may include a flag indicating DIMD merge mode use in the current block. When the flag is set, the selecting of the DIMD merge candidate from the list of DIMD merge candidates according to the indicator may include selecting the DIMD merge candidate from a predetermined position in the list of the DIMD merge candidates.

When the indicator includes the flag and an index, and the flag is set, the selecting of the DIMD merge candidate may include selecting the DIMD merge candidate in the list of DIMD merge candidates in accordance with the index.

The decoding of the current block may include generating a prediction block of the current block based on the DIMD information, and reconstructing the current block based on the prediction block and a residual of the current block obtained from the bitstream.

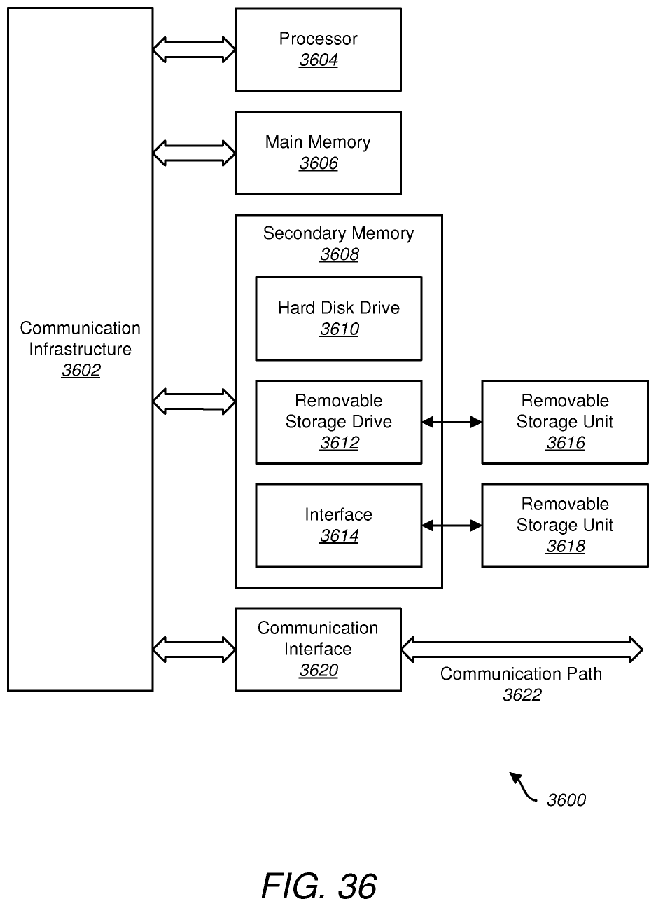

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 3600 is shown in FIG. 36. Blocks depicted in the figures above, such as the blocks in FIGS. 1, 2, and 3, may execute on one or more computer systems 3600. Furthermore, each of the steps of the flowcharts depicted in this disclosure may be implemented on one or more computer systems 3600.

Computer system 3600 includes one or more processors, such as processor 3604. Processor 3604 may be, for example, a special purpose processor, general purpose processor, microprocessor, or digital signal processor. Processor 3604 may be connected to a communication infrastructure 3602 (for example, a bus or network). Computer system 3600 may also include a main memory 3606, such as random access memory (RAM), and may also include a secondary memory 3608.

Secondary memory 3608 may include, for example, a hard disk drive 3610 and/or a removable storage drive 3612, representing a magnetic tape drive, an optical disk drive, or the like. Removable storage drive 3612 may read from and/or write to a removable storage unit 3616 in a well-known manner. Removable storage unit 3616 represents a magnetic tape, optical disk, or the like, which is read by and written to by removable storage drive 3612. As will be appreciated by persons skilled in the relevant art(s), removable storage unit 3616 includes a computer usable storage medium having stored therein computer software and/or data.

In alternative implementations, secondary memory 3608 may include other similar means for allowing computer programs or other instructions to be loaded into computer system 3600. Such means may include, for example, a removable storage unit 3618 and an interface 3614. Examples of such means may include a program cartridge and cartridge interface (such as that found in video game devices), a removable memory chip (such as an EPROM or PROM) and associated socket, a thumb drive and USB port, and other removable storage units 3618 and interfaces 3614 which allow software and data to be transferred from removable storage unit 3618 to computer system 3600.

Computer system 3600 may also include a communications interface 3620. Communications interface 3620 allows software and data to be transferred between computer system 3600 and external devices. Examples of communications interface 3620 may include a modem, a network interface (such as an Ethernet card), a communications port, etc. Software and data transferred via communications interface 3620 are in the form of signals which may be electronic, electromagnetic, optical, or other signals capable of being received by communications interface 3620. These signals are provided to communications interface 3620 via a communications path 3622. Communications path 3622 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 3616 and 3618 or a hard disk installed in hard disk drive 3610. These computer program products are means for providing software to computer system 3600. Computer programs (also called computer control logic) may be stored in main memory 3606 and/or secondary memory 3608.

Computer programs may also be received via communications interface 3620. Such computer programs, when executed, enable the computer system 3600 to implement the present disclosure as discussed herein. In particular, the computer programs, when executed, enable processor 3604 to implement the processes of the present disclosure, such as any of the methods described herein. Accordingly, such computer programs represent controllers of the computer system 3600.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
reordering a list of merge candidates, wherein the list of merge candidates comprise a merge candidate comprising decoder-side intra mode derivation (DIMD) information or template-based intra mode derivation (TIMD) information associated with a spatially neighboring block of a current block in a current frame;
determining an indicator of the merge candidate in the list of merge candidates; and
coding the current block based on the DIMD information of the merge candidate in the list of merge candidates according to the indicator.

2. The method according to claim 1, wherein the reordering comprises reordering according to template matching costs of respective merge candidates in the list of merge candidates.

3. The method according to claim 2, wherein the reordering further comprises reordering all merge candidates in the list of merge candidates.

4. The method according to claim 2, wherein the reordering further comprises reordering only a first part of the list of merge candidates.

5. The method according to claim 1, wherein the reordering comprises reordering according to a location dependency of respective merge candidates in the list of merge candidates.

6. The method according to claim 1, wherein the list of merge candidates comprises a first set of merge candidates added based on DIMD information and a second set of merge candidates added based on TIMD information.

7. The method according to claim 1, wherein each merge candidate, of the merge candidates, comprises one or more DIMD intra modes and one or more corresponding blending weights.

8. The method according to claim 7, wherein the each merge candidate further comprises one or more location dependencies corresponding to the one or more DIMD intra modes, respectively.

9. An apparatus comprising:
one or more processors; and
memory storing instructions that, when executed by the one or more processors, cause the apparatus to:
reorder a list of merge candidates, wherein the list of merge candidates comprise a merge candidate comprising decoder-side intra mode derivation (DIMD) information or template-based intra mode derivation (TIMD) information associated with a spatially neighboring block of a current block in a current frame;
determine an indicator of the merge candidate in the list of merge candidates; and
code the current block based on the DIMD information of the merge candidate in the list of merge candidates according to the indicator.

10. The apparatus according to claim 9, wherein the reordering comprises reordering according to template matching costs of respective merge candidates in the list of merge candidates.

11. The apparatus according to claim 10, wherein the reordering further comprises reordering all merge candidates in the list of merge candidates.

12. The apparatus according to claim 10, wherein the reordering further comprises reordering only a first part of the list of merge candidates.

13. The apparatus according to claim 9, wherein the reordering comprises reordering according to a location dependency of respective merge candidates in the list of merge candidates.

14. The apparatus according to claim 9, wherein the list of merge candidates comprises a first set of merge candidates added based on DIMD information and a second set of merge candidates added based on TIMD information.

15. The apparatus according to claim 9, wherein each merge candidate, of the merge candidates, comprises one or more DIMD intra modes and one or more corresponding blending weights.

16. The apparatus according to claim 15, wherein the each merge candidate further comprises one or more location dependencies corresponding to the one or more DIMD intra modes, respectively.

17. A non-transitory computer-readable medium comprising instructions that, when executed by one or more processors of an apparatus, cause the apparatus to:
reorder a list of merge candidates, wherein the list of merge candidates comprise a merge candidate comprising decoder-side intra mode derivation (DIMD) information or template-based intra mode derivation (TIMD) information associated with a spatially neighboring block of a current block in a current frame;
determine an indicator of the merge candidate in the list of merge candidates; and
code the current block based on the DIMD information of the merge candidate in the list of merge candidates according to the indicator.

18. The non-transitory computer-readable medium according to claim 17, wherein the reordering comprises reordering according to template matching costs of respective merge candidates in the list of merge candidates.

19. The non-transitory computer-readable medium according to claim 17, wherein the reordering comprises reordering according to a location dependency of respective merge candidates in the list of merge candidates.

20. The non-transitory computer-readable medium according to claim 17, wherein the list of merge candidates comprises a first set of merge candidates added based on DIMD information and a second set of merge candidates added based on TIMD information.
